(19) United States
(12) Patent Application Publication
(10) Pub. No.: US 2025/0338308 A1
(43) Pub. Date: Oct. 30, 2025

(54) METHOD OF WIRELESS COMMUNICATION, USER EQUIPMENT AND BASE-STATION FOR SMALL DATA TRANSMISSION, SDT

(71) Applicant: Continental Automotive Technologies GmbH, Hannover (DE)

(72) Inventors: Rikin Shah, Langen (DE); David Gonzalez Gonzalez, Egelsbach (DE); Andreas Andrae, Frankfurt am Main (DE); Hojin Kim, Regensburg (DE); Reuben George Stephen, Singapore (SG); Shravan Kumar Kalyankar, Singapore (SG)

(73) Assignee: Continental Automotive Technologies GmbH, Hannover (DE)

(21) Appl. No.: 18/860,700

(22) PCT Filed: Apr. 20, 2023
(86) PCT No.: PCT/EP2023/060344

§ 371 Date: Oct. 28, 2024

(30) Foreign Application Priority Data
Apr. 27, 2022 (DE) 10 2022 204 048.1

(51) Int. Cl. H04W 74/00; H04L 1/00; H04W 68/02; H04W 74/0833; H04W 76/20

(52) U.S. Cl. CPC H04W 74/006; H04L 1/0061; H04W 68/02; H04W 74/0833; H04W 76/20

(57) ABSTRACT

A method of wireless communication comprises receiving downlink control information by a user equipment in an inactive state. The downlink control information comprises a cyclic redundancy check scrambled by a radio network with at least one base-station with paging-Radio Network Temporary Identifier. The user equipment monitors paging message in inactive state and uses paging-Radio Network Temporary Identifier to decode reception of paging message, wherein the user equipment receives indication of small data transmission and identifier from radio network with at least one base-station.

### CROSS-REFERENCE TO RELATED APPLICATIONS

The present application is a National Stage Application under 35 U.S.C. § 371 of International Patent Application No. PCT/EP2023/060344 filed on Apr. 20, 2023, and claims priority from German Patent Application No. 10 2022 204 048.1 filed on Apr. 27, 2022, in the German Patent and Trademark Office, the disclosures of which are herein incorporated by reference in their entireties.

### TECHNICAL FIELD

The present disclosure relates generally to wireless communications, user equipment, base-station and in particular embodiments, to control signaling in wireless communication networks and relates to handling small data transmission to user equipment in radio access networks), when a receiver of the user equipment is in an inactive state.

### BACKGROUND

In some wireless communication networks, user equipment's (UEs) wirelessly communicate with a base station to send data to the base station and/or receive data from the base station. A wireless communication from a user equipment (UE) to a base station is referred to as an uplink (UL) communication. A wireless communication from a base station to a user equipment (UE) is referred to as a downlink (DL) communication. A wireless communication from a first user equipment (UE) to a second user equipment (UE) is referred to as a sidelink (SL) communication or a device-to-device (D2D) communication.

WO 2021 031 112 A1 discloses various aspects related to wireless communication. This application describes that a user equipment (UE) may receive, from a base station (BS), a paging communication while in an inactive mode. The paging communication may identify a random access channel (RACH) preamble for the UE. The UE may transmit, to the BS and based at least in part on receiving the paging communication, the RACH preamble in a Msg1 communication. The UE may receive, from the BS and based at least in part on transmitting the RACH preamble in the Msg1 communication, a Msg2 communication that includes mobile-terminated downlink data and an indication that the UE is to transition from the inactive mode to a connected mode with the BS. Numerous other aspects are provided.

WO2021031103A1 is describing, that a user equipment (UE) may receive, from a base station (BS), a paging communication while the UE is in an inactive mode or an idle mode. The UE may transmit, to the BS and based at least in part on receiving the paging communication, a first communication as part of a random access channel (RACH) procedure. The UE may receive, from the BS and based at least in part on transmitting the first communication, a second communication that includes mobile-terminated downlink data, an indication of an uplink resource, and a radio resource control (RRC) release message. The RRC release message may cause the UE to remain in the inactive mode or the idle mode while receiving the mobile-terminated downlink data. The UE may transmit mobile-originated uplink data using the uplink resource. Numerous other aspects are provided.

WO 2021 157 895 A1 provides a method and apparatus for small data transmission in RRC inactive state in MR-DC. A master node (MN), in a dual connectivity (DC) for a wireless device, transmits, to the wireless device, a paging message including an indication related to an early data transmission (EDT) procedure for the secondary node (SN). A MN receives, from the wireless device, an access stratum-release assistance information (AS-RAI) related to the EDT procedure for SN. A MN decides whether to continue the EDT procedure to the wireless device for the DL data or to transit the wireless device to the RRC-CONNECTED state based on the received AS-RAI.

U.S. Pat. No. 10,264,622 B2 discloses, that a base station receives from a first core network entity, packet(s) for a wireless device in an RRC inactive state. The base station initiates a radio access network (RAN) paging procedure comprising sending RAN paging message(s) to second base station(s). The RAN paging message(s) comprises a first identifier of the wireless device. The base station determines a failure of the RAN paging procedure in response to not receiving a response of the RAN paging message(s). The base station sends a first message to a second core network entity in response to the failure of the RAN paging procedure. The base station receives a second message from the second core network entity in response to the first message. The second message comprises a tunnel endpoint identifier of a third base station for forwarding the packet(s). The base station sends to the third base station, the packet(s) based on the tunnel endpoint identifier.

U.S. Pat. No. 2,021,127 414 A1 describes a control signaling mechanisms to support data transmissions to or from a user equipment (UE) in an inactive state. In some embodiments, a UE in an inactive state receives DCI including: a cyclic redundancy check (CRC) scrambled by a radio network temporary identifier (RNTI) that is specific to a group of UEs, the group of UEs including the UE; and a resource assignment for a data transmission to the UE. The data transmission is then received on a physical shared channel. In further embodiments, a UE in an inactive state receives DCI including: a CRC scrambled by a paging RNTI; and a resource assignment for a paging message to the UE. A data transmission is received by the UE in the paging message or in a further transmission that is scheduled by the paging message.

In 3GPP New Radio (NR), a user equipment (UE) may operate in one of the following three states: RRC_IDLE, RRC_CONNECTED and RRC_INACTIVE.

In the RRC_CONNECTED state, a user equipment (UE) is connected to the network following a connection establishment procedure. In the RRC_IDLE state, a user equipment (UE) is not connected to the network, but the network knows, that the user equipment (UE) is present in the network. Switching to the RRC_IDLE state helps save network resources and user equipment (UE) power, for example battery life, when the user equipment (UE) is not communicating with the network.

The inactive mode (RRC_INACTIVE) state also helps save network resources and user equipment (UE) power when the user equipment (UE) is not communicating with the network. However, unlike the RRC_IDLE state, when a user equipment (UE) is in the inactive mode (RRC_INACTIVE) state the network and the user equipment (UE) both store at least some configuration information to allow the user equipment (UE) to reconnect to the network more rapidly.

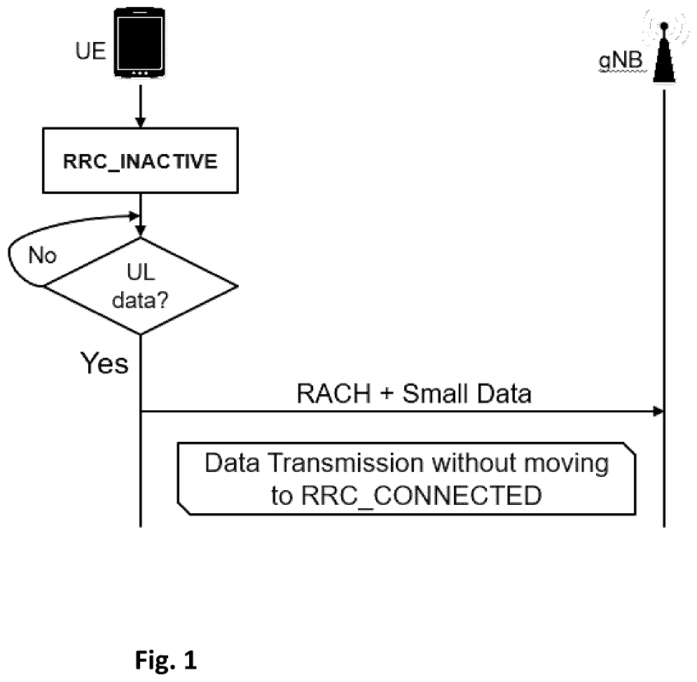

To reduce signalling overhead and latency, 3GPP TS 38.331 Release 17 introduced support for mobile-originated small data transmission (SDT) in RRC inactive mode. A simplified schematic flow diagram of the SDT in this case is shown in FIG. 1. The user equipment (UE), while in the RRC_INACTIVE operating mode, determines, if it has data to transmit to the RAN. In the positive case, “yes”-branch the user equipment (UE), will perform the RACH procedure, RACH being the abbreviation for random access channel, and the RACH procedure normally serves for connecting and synchronising the user equipment (UE) to the best base-station (gNB) of the RAN. A small amount of data may be transmitted in the RACH procedure without transitioning from the RRC_INACTIVE operating mode to a fully connected state, i.e., RRC_CONNECTED.

Currently, the 3rd Generation Partnership Project (3GPP) works at the technical specifications for the next generation cellular technology, which is also called fifth generation (5G) or sixth generation (6G).

Current versions of 3GPP TS 38.331 do not specify mobile-terminated small data transmission in RRC_INACTIVE mode, and any mobile-terminated data transmission will require the UE to transition into the fully connected state, i.e., RRC_CONNECTED.

Enhanced mobile broadband (eMBB) deployment scenarios may include indoor hotspot, dense urban, rural, urban macro and high speed; ultra-reliable low-latency communications (URLLC) deployment scenarios may include industrial control systems, mobile health care (remote monitoring, diagnosis and treatment), real time control of vehicles, wide area monitoring and control systems for smart grids; massive machine type communication (mMTC) deployment scenarios may include scenarios with large number of devices with non-time critical data transfers such as smart wearables and sensor networks. The services eMBB and URLLC are similar in that, that they both demand a very broad bandwidth, however, are different in that the URLLC service may require ultra-low latencies. Conventionally, when a user equipment (UE) is in the inactive mode (RRC_INACTIVE) state, data transmission to and from the user equipment (UE) is limited.

### SUMMARY

In 5G, they have introduced new RRC Status called “RRC_Inactive” to minimize latency as well as to reduce signalling load. Transitions from RRC_Inactive to Connected is very quick as UE Context is stored at base-station (gNB) and UE. Next Generation (NG) signalling keep alive between base-station (gNB) to access and mobility management function (AMF), GTP-U also remain alive between base-station (gNB) to user plane function (UPF). In case when DL small data transmission is ongoing, and if in the middle of that, UE wants to initiate UL data transmission, which can be either UL small data or UL non-small data, then the current UE behavior and procedure is not defined

One non-limiting and exemplary embodiment facilitates providing procedures for facilitating a user equipment (UE) to transmit small data, for example when the user equipment (UE) is in an inactive state. In an embodiment, the user equipments (UE) s disclosed here feature a user equipment comprising the following. A processor of the user equipment (UE) determines that a transmission of small data is to be performed. The user equipment (UE) is in an inactive state with at least one data connection to a radio base station that controls a radio cell in which the user equipment (UE) is located. The user equipment (UE) is assigned at least with a cell-specific user equipment (UE) identification and a non-cell-specific user equipment (UE) identification. The processor determines which user equipment (UE) identification to use for the small data transmission, based on whether the user equipment (UE), after having transitioned to the inactive state, has moved to the current radio cell from another radio cell. In case the user equipment (UE) has moved to the current radio cell from another radio cell, the processor determines to use the non-cell-specific user equipment (UE) identification for the small data transmission. In case the user equipment (UE) has not moved to the current radio cell from another radio cell, the processor determines to use the cell-specific user equipment (UE) identification for the small data transmission.

The User equipment (UE) receives indication whether the network has one shot downlink (DL) data transmission or multiple shot data transmission in the paging message. In order to create a signaling 1 bit is used to indicate such information (1 indicates-multiple shot downlink (DL) data transmission, 0 indicates-single shot downlink (DL) data transmission).

In case of base-station (gNB) indicates one shot downlink (DL) data transmission, then user equipment (UE) performs uplink (UL) data transmission after receiving downlink (DL) data as shown in FIG. 1

User equipment (UE) can make transition from RRC_Connected state to RRC_Inactive state using RRC Release with Suspend procedure. A Suspend-config parameter is in RRC Release message which provides information to UE, like RNA Update, Paging Cycle etc.

As NG signalling will be alive between Access Mobility Management Function (AMF) and base-station (gNB), AMF can request to provide UE States information from base-station (gNB) by “Initial UE Context Setup Request or Modification Request” or base-station (gNB) can provide subsequently update to AMF by “RRC Inactive Transition Report”. This would help AMF to configure its supervision timer for getting response for DL notification.

Base-station (gNB) will provide full (40 Bits) and Short (24 bits) I-RNTI (Inactive Radio Network Temporary Identity). Base-station (gNB) will use Full I-RNTI during RRC Paging message. User equipment (UE) can use either Short or Full depending on coverage, UE at cell edge with low coverage can use short I-RNTI (RRC resume request can send during RACH as msg3 that means it cannot be segmented and use single transport block). Message length is relatively less compared to RRC resume request 1 (Full I-RNTI).

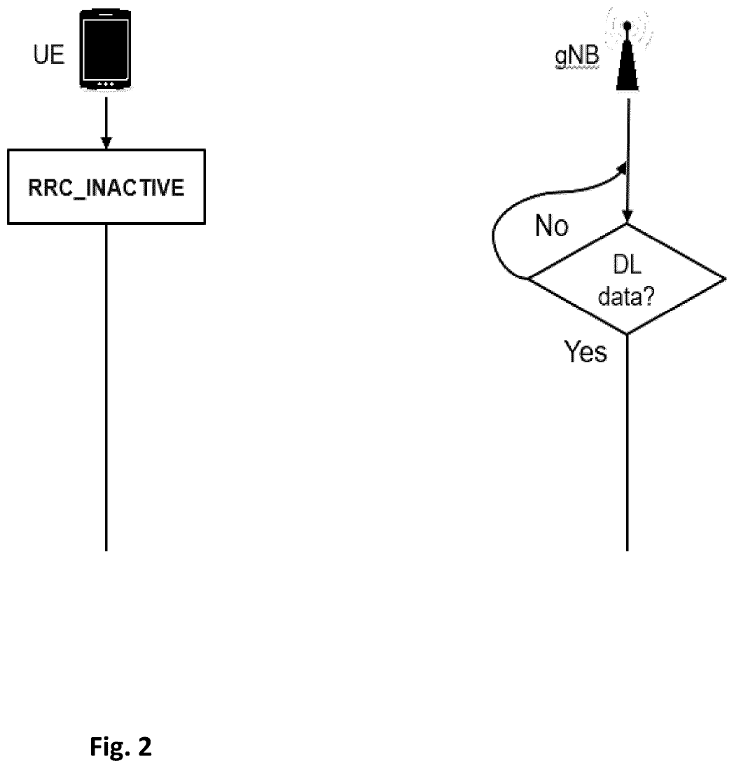

In case of base-station (gNB) indicates multi shot downlink (DL) data transmission, then user equipment (UE) sends indication of available uplink (UL) data to the network as shown in FIG. 2. User equipment (UE) uses Configured grant based small data transmission (CG-SDT) or Random Access based small data transmission (RA-SDT) resources and sends indication through Medium Access Control Control Element (MAC CE) where Configured grant based small data transmission (CG-SDT) resources and RA-SDT resources are broadcasted through system information or configured through dedicated signaling message. The user equipment (UE) further indicates whether available uplink (UL) data is small data or non-small data along with priority.

Based on such information from user equipment (UE), base-station (gNB) suspended downlink (DL) data transmission and resumes it after receiving uplink (UL) data from user equipment (UE) in inactive mode (RRC_INACTIVE) or RRC_CONNECTED mode.

A transmitter of the user equipment (UE) transmits a control message including the determined user equipment (UE) identification and transmits the small data using one of the at least one data connection.

In case when downlink (DL) small data transmission is ongoing, and if in the middle of that, the user equipment (UE) wants to initiate uplink (UL) data transmission, which can be either uplink (uplink (UL)) small data or uplink (uplink (UL)) non-small data, then the current user equipment (UE) behavior and procedure is not stably defined.

Generally spoken the purpose of the embodiments is to reduce signaling overhead and latency for mobile originated small data transmission in RRC_INACTIVE mode.

It should be noted that general or specific embodiments may be implemented as a system, a method, an integrated circuit, a computer program, a storage medium, or any selective combination thereof.

Additional benefits and advantages of the disclosed embodiments and different implementations will be apparent from the specification and figures. The benefits and/or advantages may be individually obtained by the various embodiments and features of the specification and drawings, which need not all be provided in order to obtain one or more of such benefits and/or advantages.

### BRIEF SUMMARY AND DESCRIPTION OF THE FIGURES

In the following exemplary embodiments are described in more detail with reference to the attached figures and drawings.

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to techniques for optimizing delivery of data to and/or from a user equipment to a radio network with at least one base-station.

Certain aspects of the present disclosure provide a method for wireless communication. The method generally includes receiving downlink control information (DCI) comprising by a user equipment (UE) in an inactive state (RRC_INACTIVE), a cyclic redundancy check (CRC) scrambled by a radio network with at least one base-station (gNB) with identifier (C-RNTI) that is specific to a group of UEs, the group of UEs including the UE, and a resource assignment for a data transmission from at least a base-station (gNB) to the user equipment (UE); and receiving, by the user equipment (UE) in the inactive state (RRC_INACTIVE), the data transmission on a physical shared channel, wherein the user equipment (UE) receives more than one random-access channel (RACH) resource configuration.

Certain aspects of the present disclosure provide a method for wireless communication, whereby the user equipment (UE) receives indication of priority of downlink (DL) data in the paging message.

Certain aspects of the present disclosure provide a method for wireless communication, whereby user equipment (UE) receives indication of group ID in the paging message.

Certain aspects of the present disclosure provide a method for wireless communication, whereby user equipment (UE) receives mapping between priority and group ID and random-access channel (RACH) resources configuration.

Certain aspects of the present disclosure provide a method for wireless communication, whereby user equipment (UE) whereby mapping in the system information or dedicated RRC message.

Certain aspects of the present disclosure provide a method for wireless communication, whereby user equipment (UE) selects random-access channel (RACH) resources corresponding to the priority and/or group ID indicated in the paging message.

Certain aspects of the present disclosure provide a method for wireless communication, whereby base-station (gNB) configures more than one random-access channel (RACH) resources per Synchronization Signal Block (SSB).

Certain aspects of the present disclosure provide a method for wireless communication, whereby base-station (gNB) configures a mapping of the random-access channel (RACH) resources based on at least one option.

Certain aspects of the present disclosure provide a method for wireless communication wherein whereby the option is a selection of priorities P1, P2 and P3 and priority P1 is linked to random-access channel (RACH) resources 1, priority P2 is linked to random-access channel (RACH) resources 2, priority P3 is linked to random-access channel (RACH) resources 3.

Certain aspects of the present disclosure provide a method for wireless communication whereby the option is a selection of group ID1, group ID2 and group ID3 and group ID1 is linked to random-access channel (RACH) resources 1, group ID2 is linked to random-access channel (RACH) resources 2, group ID3 is linked to random-access channel (RACH) resources 3.

Certain aspects of the present disclosure provide a method for wireless communication whereby the mapping is done through system Information or dedicated RRC message.

Certain aspects of the present disclosure provide a method for wireless communication, whereby base-station (gNB) indicates priorities P1, P2, P3 and/or group ID1, group ID1, group ID2, group ID3 in the paging message and user equipment (UE) selects random-access channel (RACH) resources.

Certain aspects of the present disclosure provide A user equipment (UE) for wireless communication, comprising:

A memory; and one or more processors coupled to the memory, the memory and the one or more processors configured to:
receive, from a base-station (gNB), a paging communication while the user equipment (UE) is in an inactive mode (RRC_INACTIVE) or an idle mode (RRC_IDLE);
transmit, to the base-station (gNB) and based at least in part on receiving the paging communication, a first communication as part of a random access channel (RACH) procedure; and
receive, from base-station (gNB) and based at least in part on transmitting the first communication, a second communication that includes:
mobile-terminated downlink data (DL), an indication of an uplink (UL) resource, and a radio resource control (RRC) release message that causes the user equipment (UE) to remain in the inactive mode (RRC_INACTIVE) or the idle mode (RRC_IDLE); while receiving the mobile-terminated downlink data; and transmit to a base-station (gNB) and while in the inactive mode or the idle mode, mobile-originated uplink data using the up link (UL) resource,
wherein the memory stores computer program instructions which, when executed by the microprocessor, configure the user equipment (UE) to implement the method-of the embodiments.

Certain aspects of the present disclosure provide a base-station (gNB) for wireless communication, comprising:
a memory; and one or more processors coupled to the memory, the memory and the one or more processors configured to:
transmit, to a user equipment (UE), a paging communication while the user equipment (UE) is in an inactive mode (RRC_INACTIVE) or an idle mode (RRC_IDLE);
receive, from the user equipment (UE) and based at least in part on transmitting the paging communication, a first communication as part of a random access channel (RACH) procedure; and transmit to the user equipment (UE) and based at least in part on transmitting the first communication, a second communication that includes: mobile-terminated downlink (DL) data, an uplink (UL) resource that the user equipment (UE) is to use to transmit mobile-originated uplink data while in the inactive mode or the idle mode, and a radio resource control (RRC) release message that causes the user equipment (UE) receive the mobile-terminated downlink (DL) data while in the inactive mode (RRC_INACTIVE) or the idle mode (RRC_IDLE); and receive, from the user equipment (UE) and in the uplink (UL) resource, mobile-originated up link data, the user equipment (UE) is to transmit the mobile-originated uplink data while in the inactive mode or the idle mode,
wherein the memory stores computer program instructions which, when executed by the microprocessor, configure the user equipment (UE) via the base-station (gNB) to implement the method-of the embodiments.

Certain aspects of the present disclosure provide a non-transitory computer-readable medium storing one or more instructions for wireless communication, the one or more instructions comprising:
one or more instructions that, when executed by one or more processors of a user equipment (UE), cause the one or more processors to:
receive, from base-station (gNB), a paging communication while the user equipment (UE) is in inactive mode (RRC_INACTIVE) or the idle mode (RRC_IDLE);
transmit, to the base-station (gNB) and based at least in part on receiving the paging communication, a first communication as part of a random access channel (RACH) procedure; and receive, from the base-station (gNB) and based at least in part on transmitting the first communication, a second communication that includes:
mobile-terminated downlink (DL) data, an indication of an uplink (UL) resource, and a radio resource control (RRC) release message that causes the user equipment (UE) to remain in the inactive mode (RRC_INACTIVE) or the idle mode (RRC_IDLE), while receiving the mobile-terminated downlink data; and transmit, to the base-station (gNB) and while in inactive mode (RRC_INACTIVE) or the idle mode (RRC_IDLE), mobile-originated uplink (UL) data using the uplink (UL) resource.
wherein the non-transitory computer-readable medium stores computer program instructions which, when executed by the microprocessor, configure the user equipment (UE) to implement the method of the embodiments. One or more instructions that, when executed by one or more processors of a base-station (gNB), cause the one or more processors to:
Transmit, to a user equipment (UE), a paging communication while the user equipment (UE) is in inactive mode (RRC_INACTIVE) or the idle mode (RRC_IDLE);
receive, from the user equipment (UE) and based at least in part on transmitting the paging communication, a first communication as part of a random access channel (RACH) procedure; and transmit, to the user equipment (UE) and based at least in part on transmitting the first communication, a second communication that includes: mobile-terminated downlink (DL) data, an uplink (UP) resource that the user equipment (UE) is to use to transmit mobile-originated uplink (UP) data while in inactive mode (RRC_INACTIVE) or the idle mode (RRC_IDLE), and a radio resource control (RRC) release message that causes the user equipment (UE) receive the mobile-terminated downlink (DL) data while in inactive mode (RRC_INACTIVE) or the idle mode (RRC_IDLE), and
receive, from the user equipment (UE) and in the uplink (UL) resource, mobile-originated uplink (UL) data, the user equipment (UE) is to transmit the mobile-originated uplink (UL) data while in inactive mode (RRC_INACTIVE) or the idle mode (RRC_IDLE),
wherein the non-transitory computer-readable medium stores computer program instructions which, when executed by the microprocessor, configure the user equipment (UE) to implement the method of-the embodiments.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

While the embodiments have been described with a focus on a radio access network in accordance with the 3GPP TS 38.211, TS 38.212, TS 38.213, TS 38.300, TS 38.321 and TS 38.331 standard family, also referred to as 5G NR, they may also be used in further developments thereof, e.g., the future 6G standard. Also, while the embodiments have been described with a focus on the RRC_INACTIVE operating mode, they are not limited thereto, but may be used in all wireless systems in which UEs need to connect to network infrastructure for data transmission and reception and disable a receiver when not actively communicating, and which provide a mechanism via which small amounts of data can be transmitted without fully connecting to the network infrastructure. For example, any term used in this specification for identifying a component or device, such as gNB for a base station of the RAN, is not meant to limit the embodiments to standards using the very same terms for components or devices performing the same function.

### BRIEF DESCRIPTION OF THE DRAWINGS

FIG. 1 shows the user equipment (UE) sends uplink (UL) small data transmission in inactive mode (RRC_INACTIVE) state without moving to RRC_CONNECTED.

FIG. 2 shows downlink (downlink (DL)) small data available to base-station (gNB) when user equipment (UE) is in inactive mode (RRC_INACTIVE).

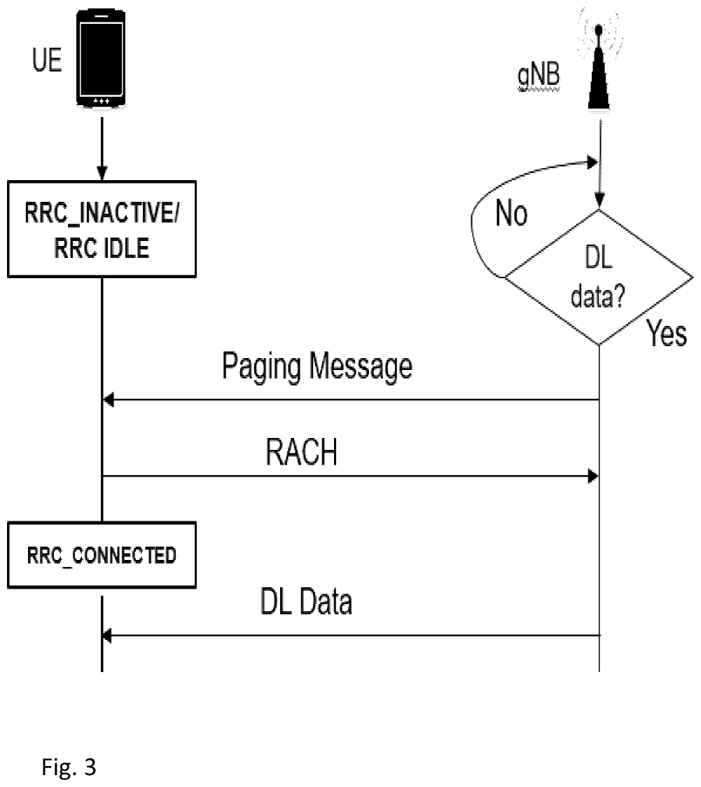

FIG. 3 user equipment (UE) moves to RRC_CONNECTED state to receive Downlink data transmission from base-station (gNB).

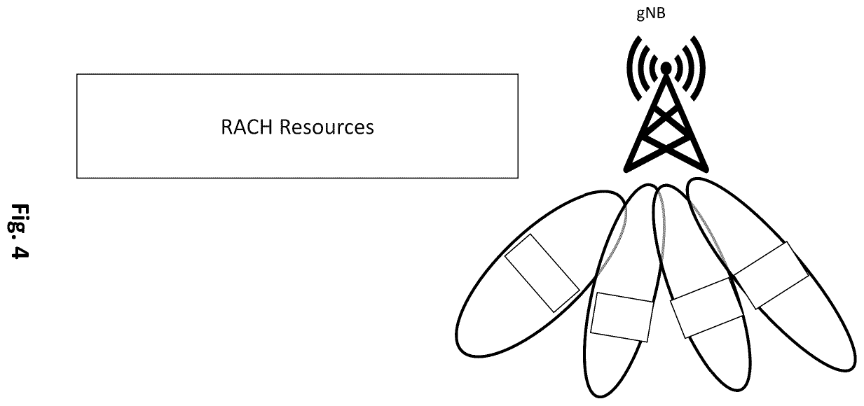

FIG. 4 illustrates the configuration of one random-access channel (RACH) resources per Synchronization Signal Block (SSB) by base-station (gNB).

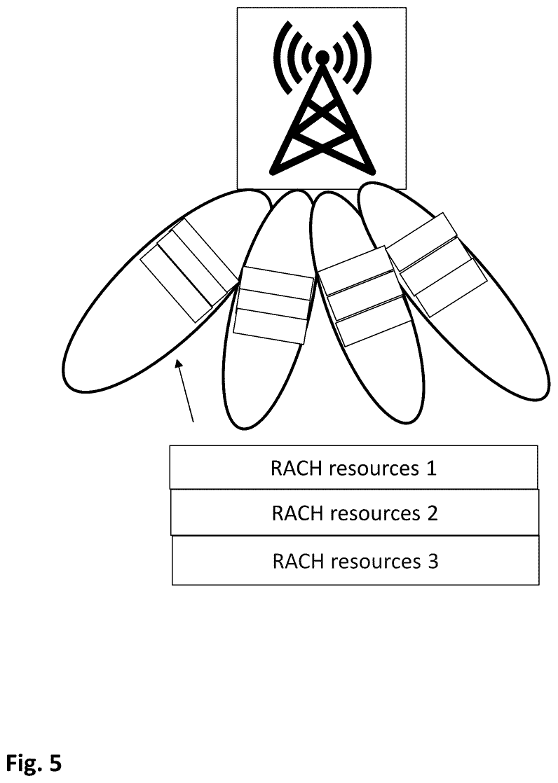

FIG. 5 shows one base-station (gNB) configures more than one random-access channel (RACH) resources per Synchronization Signal Block (SSB).

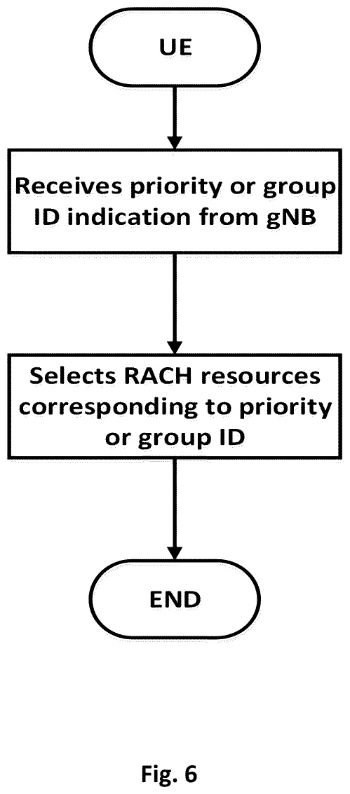

FIG. 6 shows the provided the flow chart for user equipment (UE) side.

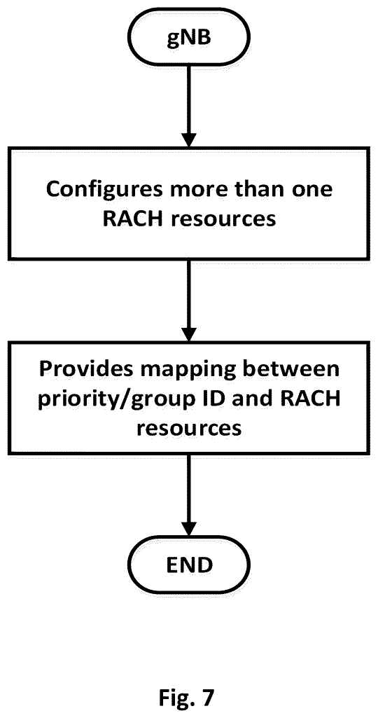

FIG. 7 shows the provided the flow chart for base-station (gNB) side.

### DETAILED DESCRIPTION

To reduce the signaling overhead, the base station (gNB) can schedule the downlink transmission without entailing the user equipment (UE) to be in the connected state. For this purpose, the user equipment (UE) can be scheduled with the predefined cell and beam, used for the earlier transmissions. Such information user equipment (UE) can receive either in dedicated RRC message or paging message.

FIG. 1 shows the user equipment (UE) sends uplink (UL) small data transmission in inactive mode (RRC_INACTIVE) state without moving to RRC_CONNECTED.

In 5G, they have introduced a new RRC State called “RRC Inactive” to minimize latency as well as to reduce signaling load. Transitions from RRC Inactive to Connected is very quick as user equipment (UE) Context is stored at base-station (gNB) and user equipment (UE). NG signaling keep alive between base-station (gNB) to AMF, GTP-U also remain alive between base-station (gNB) to User Plane Function (UPF). User equipment (UE) can make transition from RRC Connected state to Inactive state using RRC Release with Suspend procedure. A Suspend-config parameter is in RRC Release message which provides information to user equipment (UE) (RNA Update, Paging Cycle etc).

As NG signalling will be alive between AMF and base-station (gNB), AMF can request to provide user equipment (UE) States information from base-station (gNB) by “Initial UE Context Setup Request or Modification Request” or base-station (gNB) can provide subsequently update to AMF by “RRC Inactive Transition Report”, This would help AMF to configure its supervision timer for getting response for DL notification.

Base-station (gNB) will provide full (40 Bits) and Short (24 bits) I-RNTI (Inactive Radio Network Temporary Identity). Base-station (gNB) will use Full I-RNTI during RRC Paging message. User equipment (UE) can use either Short or Full depends on coverage, user equipment (UE) at cell edge with low coverage can use short I-RNTI, RRC resume request can send during RACH as msg3 that means it cannot be segmented and use single transport block. Message length is relatively less compared to RRC resume request 1 (Full I-RNTI). In case of base-station (gNB) indicates one shot downlink (DL) data transmission, then user equipment (UE) performs uplink (UL) data transmission after receiving downlink (DL) data. To reduce signalling overhead and latency, 3GPP TS 38.331 Release 17 introduced support for mobile-originated SDT in RRC inactive mode. A simplified schematic flow diagram of the SDT in this case is shown in FIG. 1

### 5G NR System Architecture and Protocol Stacks

3GPP has been working at the next release for the 5th and on the 6th generation cellular technology, simply called 5G or 6G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

Current versions of 3GPP TS 38.331 do not specify mobile-terminated small data transmission in RRC_INACTIVE mode, and any mobile-terminated data transmission will require the UE to transition into the fully connected state, i.e., RRC_CONNECTED.

Among other things, the overall system architecture assumes an NG-RAN (Next Generation-Radio Access Network) that comprises base-stations (gNBs), providing the NG-radio access user plane (SDAP/PDCP/RLC/MAC/PHY) and control plane (RRC) protocol terminations towards the user equipment (UE). The base-stations (gNBs) are interconnected with each other by means of the Xn interface. The base-stations (gNBs) are also connected by means of the Next Generation (NG) interface to the NGC (Next Generation Core), more specifically to the AMF (Access and Mobility Management Function), e.g. a particular core entity performing the AMF by means of the NG-C interface and to the UPF (User Plane Function), e.g. a particular core entity performing the UPF by means of the NG-U interface. The NG-RAN architecture is described in 3GPP TS 38.300 v16.0.0, section 4.

The user plane protocol stack for NR, see 3GPP TS 38.300, section 4.4.1, comprises the PDCP (Packet Data Convergence Protocol, see section 6.4 of TS 38.300), RLC (Radio Link Control, see section 6.3 of TS 38.300) and Medium Access Control (MAC) (Medium Access Control, see section 6.2 of TS 38.300) sublayers, which are terminated in the base-station (gNB) on the network side. Additionally, a new access stratum (AS) sublayer (SDAP, Service Data Adaptation Protocol) is introduced above PDCP, sub-clause 6.5 of 3GPP TS 38.300. A control plane protocol stack is also defined for NR, for instance TS 38.300, section 4.4.2. An overview of the Layer 2 functions is given in sub-clause 6 of TS 38.300. The functions of the RRC layer are listed in sub-clause 7 of TS 38.300.

The Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for uplink (UL) and downlink (DL) each for user plane latency) and high reliability (1-1 05 within 1 ms). Finally, mMTC may require high connection density (1,000,000 devices/km2 in an urban environment), large coverage in harsh environments, and extremely long-life battery for low-cost devices (15 years).

Therefore, the OFDM numerology, e.g. subcarrier spacing, OFDM symbol duration, cyclic prefix (CP) duration, number of symbols per scheduling interval, that is suitable for one use case might not work well for another. For example, low-latency services may preferably require a shorter symbol duration and thus larger subcarrier spacing and/or fewer symbols per scheduling interval (aka, TTI) than an mMTC service. Furthermore, deployment scenarios with large channel delay spreads may require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz are being considered now. The symbol duration Tᵤ and the subcarrier spacing A_{f} are directly related through the formula A_{f}=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink (UL) and downlink (DL). Each element in the resource grid is called a resource element and is identified based on the frequency index in the frequency domain and the symbol position in the time domain (see 3GPP TS 38.211 v16.0.0, e.g. section 4). For instance, downlink (DL) and uplink (UL) transmissions are organized into frames with 10 ms duration, each frame consisting of ten subframes of respectively 1 ms duration. In 5 g NR implementations the number of consecutive OFDM symbols per subframe depends on the subcarrier-spacing configuration. For example, for a 15-kHz subcarrier spacing, a subframe has 14 OFDM symbols, similar to an LTE-conformant implementation, assuming a normal cyclic prefix. On the other hand, for a 30-kHz subcarrier spacing, a subframe has two slots, each slot comprising 14 OFDM symbols.

### Radio Resource Control (RRC)

The Radio Resource Control (RRC) protocol is used in on the Air Interface. The major functions of the RRC protocol include connection establishment and release functions, broadcast of system information, radio bearer establishment, reconfiguration and release, RRC connection mobility procedures, paging notification and release and outer loop power control. By means of the signaling functions, the RRC configures the user and control planes according to the network status and allows for Radio Resource Management strategies to be implemented.

### The RRC Services and Functions

The main services and functions of the RRC sublayer include:
Broadcast of System Information related to AS and NAS.
Paging initiated by 5GC or NG-RAN.
Establishment, maintenance, and release of an RRC connection between the user equipment (UE) and NG-RAN including
Addition, modification, and release of carrier aggregation
Addition, modification, and release of Dual Connectivity in NR or between E-UTRA and NR.
Security functions including key management
Establishment, configuration, maintenance, and release of Signalling

RadioBearers (SRBs) and Data Radio Bearers (DRBs);
Mobility functions including:
Handover and context transfer.
UE cell selection and reselection and control of cell selection and reselection
Inter-RAT mobility
QoS management functions.
UE measurement reporting and control of the reporting
Detection of and recovery from radio link failure
NAS message transfer to/from NAS from/to UE.

The operation of the RRC is guided by a state machine which defines certain specific states that a UE may be present in. The different RRC states in this state machine have different amounts of radio resources associated with them and these are the resources that the UE may use when it is present in a given specific state.

### The RRC States in 5G New Radio (5GNR)

Apart from RRC connected and RRC IDLE state, 5G NR has introduced a new RRC state named as RRC Inactive state.
NR-RRC CONNECTED
NR-RRC INACTIVE
NR-RRC IDLE

When user equipment (UE) is power up it is in Disconnected mode/Idle mode, it can move RRC connected with initial attach or with connection establishment. If there is no activity from user equipment (UE) for a short time, it can suspend its session by moving to RRC Inactive and can resume its session moving to RRC connected mode.

A UE can move to RRC Idle mode from RRC connected or RRC Inactive state.

According to 38.300 specification section 7.2, RRC supports the following states which can be characterized as follows.

RRC Idle Mode Operations:
PLMN selection.
Broadcast of system information.
Cell re-selection mobility
Paging for mobile terminated data is initiated by 5GC
Paging for mobile terminated data area is managed by 5GC
DRX for CN paging configured by NAS

RRC Inactive Mode Operation:
Broadcast of system information.
Cell re-selection mobility.
Paging is initiated by NG-RAN (RAN paging).
RAN-based notification area (RNA) is managed by NG-RAN.
DRX for RAN paging configured by NG-RAN
5GC-NG-RAN connection (both C/U-planes) is established for UE
The UE AS context is stored in NG-RAN and the UE
NG-RAN knows the RNA which the UE belongs to

RRC Connected Mode Operation:
5GC-NG-RAN connection (both C/U-planes) is established for UE.
The UE AS context is stored in NG-RAN and the UE.
NG-RAN knows the cell which the UE belongs to
Transfer of unicast data to/from the UE
Network controlled mobility including measurements

The RRC States is a solution to the system access, power saving, and mobility optimization. 5G has to support eMBB, URLLC, and Massive IoT services at same cost and energy dissipation per day per area.

5G system access and requested services have different characteristics. Control of connectivity for future services need to flexible and programmable. To meet these different services characteristics, it requires new RRC state model.

To support URLLC services which transmits small packets that require ultra-low latency and/or high reliability Massive IoT Devices wakes up seldom power saving mode to transmit and receive a small payload.

Devices need to camp in low activity state, and sporadically transmits uplink (UL) data and/or status reports with small payload to the network.

Devices need periodic and/or sporadic downlink (DL) small packet transmission.

When user equipment (UE) is in the connected state, and sporadically transmit uplink (UL) data and/or status reports with small payload to the network.

Smartphones and consumer devices which eMBB use equipment (UE) have periodic and/or sporadic uplink (UL) and/or downlink (DL) small packet transmission and extreme data rates.

5G NR functional split between NG-RAN and 5GC

There is a functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
CoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions: Non-Access Stratum, NAS, signalling termination;
NAS signalling security;
Access Stratum, AS, Security control;
Inter Core Network, CN, node signalling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification. RRC connection setup and reconfiguration procedures

FIG. 2 shows downlink (DL) small data available to base-station (gNB) when user equipment (UE) is in inactive mode (RRC_INACTIVE). This means that user equipment (UE) is staying in inactive mode (RRC_INACTIVE) state and on base-station (gNB) side downlink (DL) data is available. In the status the definition of the user equipment (UE) is not set in a fixed manner.

As already mentioned, RRC is a higher layer signaling (protocol) used for user equipment (UE) and base-station (gNB) configuration. In particular, this transition involves that the AMF prepares the user equipment (UE) context data (including e.g. PDU session context, the Security Key, user equipment (UE) Radio Capability and user equipment (UE) Security Capabilities, etc.) and sends it to the base-station (gNB) with the INITIAL CONTEXT SETUP REQUEST. Then, the base-station (gNB) activates the AS security with the UE, which is performed by the base-station (gNB) transmitting to the UE a SecurityModeCommand message and by the UE responding to the base-station (gNB) with the SecurityModeComplete message. Afterwards, the base-station (gNB) performs the reconfiguration to setup the Signaling Radio Bearer 2, SRB2, and Data Radio Bearer(s), DRB(s) by means of transmitting to the user equipment (UE) the RRCReconfiguration message and, in response, receiving by the base-station (gNB) the RRCReconfigurationComplete from the user equipment (UE). For a signaling-only connection, the steps relating to the RRCReconfiguration are skipped since SRB2 and DRBs are not setup. Finally, the base-station (gNB) informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a base-station (gNB), and a transmitter which, in operation, transmits an initial context setup message, via the NG connection, to the base-station (gNB) to cause a signaling radio bearer setup between the base-station (gNB) and a user equipment (UE). In particular, the base-station (gNB) transmits a Radio Resource Control, RRC, signaling containing a resource allocation configuration information element to the UE via the signaling radio bearer. The UE then performs an uplink transmission or a downlink reception based on the resource allocation configuration.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 106 level), higher availability, packet sizes of up to 256 bytes, time synchronization down to the order of a few ps where the value can be one or a few ps depending on frequency range and short latency in the order of 0.5 to 1 ms in particular a target user plane latency of 0.5 ms, depending on the use cases.

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also, PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### Qos Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

TS 23.501 v16.3.0, section 4.2.3 illustrates a 5G NR non-roaming reference architecture. An Application Function (AF), e.g. an external application server hosting 5G services, exemplarily. An interaction with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

Functional units of the 5G architecture are well known, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMBB and mMTC services to at least one of functions (for example NEF, AMF, SMF, PCF, UPF, etc.) of the 5GC to establish a PDU session including a radio bearer between a gNodeB and a UE in accordance with the QoS requirement and control circuitry, which, in operation, performs the services using the established PDU session.

### Random Access Procedure

Similar to LTE, 5G NR provides a RACH (Random Access Channel) procedure (or simply random access procedure). For instance, the RACH procedure can be used by the UE to access a cell it has found. The RACH procedure can also be used in other contexts within NR, for example:
For handover, when synchronization is to be established to a new cell;
To reestablish uplink synchronization to the current cell if synchronization has been lost due to a too long period without any uplink transmission from the device;
To request uplink scheduling if no dedicated scheduling request resource has been configured for the device.

There are numerous events that may trigger the UE to perform a random access procedure, like It is described in 3GPP TS 38.300, v16.0.0 section 9.2.6.

A mobile terminal can be scheduled for uplink transmission, if its uplink transmission is time synchronized. Therefore, the Random Access Channel (RACH) procedure plays a role as an interface between non-synchronized mobile terminals (UEs) and the orthogonal transmission of the uplink radio access. For instance, the Random Access is used to achieve uplink time synchronization for a user equipment, which either has not yet acquired, or has lost, its uplink synchronization. Once a user equipment has achieved uplink synchronization, the base station can schedule uplink transmission resources for it. One scenario relevant for random access is where a user equipment in RRC_CONNECTED state, handing over from its current serving cell to a new target cell, performs the Random Access Procedure in order to achieve uplink time-synchronization in the target cell.

There can be two types of random access procedures allowing access to be either contention based, i.e. implying an inherent risk of collision, or contention free (non-contention based). An exemplary definition of a random access procedure can be found in 3GPP TS 38.321, v15.8.0 section 5.1.

The RACH procedure will be described in the following in more detail. This procedure consists of four “steps”, and thus can be termed for example as a 4-step RACH procedure. First, the user equipment transmits a random access preamble on the Physical Random Access Channel (PRACH) to the base station (i.e. message 1 of the RACH procedure). After the base station has detected a RACH preamble, it sends a Random Access Response (RAR) message (message 2 of the RACH procedure) on the PDSCH (Physical Downlink Shared Channel) addressed on the PDCCH with the (Random Access) RA-RNTI identifying the time-frequency and slot in which the preamble was detected. If multiple user equipment transmitted the same RACH preamble in the same PRACH resource, which is also referred to as collision, they would receive the same random access response message. The RAR message may convey the detected RACH preamble, a timing alignment command (TA command) for synchronization of subsequent uplink transmissions based on the timing of the received preamble, an initial uplink resource assignment (grant) for the transmission of the first scheduled transmission and an assignment of a Temporary Cell Radio Network Temporary Identifier (T-CRNTI). This T-CRNTI is used by the base station to address the mobile(s) whose RACH preamble was detected until the RACH procedure is finished, since the “real” identity of the mobile at this point is not yet known by the base station.

The user equipment monitors the PDCCH for reception of the random access response message within a given time window (e.g. termed RAR reception window), which can be configured by the base station. In response to the RAR message received from the base station, the user equipment transmits the first scheduled uplink transmission on the radio resources assigned by the grant within the random access response. This scheduled uplink transmission conveys the actual message with certain functionality such as the RRC Connection Request, a RRC Resume Request or the buffer status report.

In case of a preamble collision having occurred in the first message of the RACH procedure, i.e. multiple user equipment have sent the same preamble on the same PRACH resource, the colliding user equipments will receive the same T-CRNTI within the random access response and will also collide in the same uplink resources when transmitting their scheduled transmission in the third step of the RACH procedure. In case the scheduled transmission from one user equipment is successfully decoded by base station, the contention remains unsolved for the other user equipment(s). For resolution of this type of contention, the base station sends a contention resolution message (a fourth message) addressed to the C-RNTI or Temporary C-RNTI. This concludes the procedure.

The base station provides in a first step the user equipment with the dedicated preamble to use for random access so that there is no risk of collisions, i.e. multiple user equipments transmitting the same preamble. Accordingly, the user equipment is subsequently sending the preamble that was signaled by the base station in the uplink on a PRACH resource. Since the case that multiple UEs are sending the same preamble is avoided for a contention-free random access, essentially, a contention-free random access procedure is finished after having successfully received the random access response by the UE.

3GPP is also studying a 2-step (contention-based) RACH procedure for 5G NR, where a message 1 (termed as MSGA), that corresponds to messages 1 and 3 in the four-step LTE/NR RACH procedure, is transmitted at first. The MSGA of the 2-step RACH type includes a preamble on the Physical Random Access Channel (PRACH) and a payload on the Physical Uplink Shared Channel (PUSCH). After MSGA transmission, the UE monitors for a response from the base-station (gNB) within a configured time window. Then, the base-station (gNB) will respond with a message 2 (termed as MSGB), corresponding to messages 2 and 4 of the 4-step LTE/NR RACH procedure. This msgB can include e.g. a Success random access response (RAR), a Fallback RAR, and optionally a backoff indication. If contention resolution is successful upon receiving the Success RAR, the UE ends the random access procedure; while if Fallback RAR is received in MSGB, the UE performs message 3 transmission (as in 4-step RACH procedure) and monitors contention resolution. Some further exemplary assumptions are made for the 2-step RACH procedure, such as that the UE, after deciding on the RACH type (e.g. the 2-step RACH), keeps retrying that same RACH type until failure. But there may be also the possibility that the UE can switch to the 4-step RACH procedure after certain reattempts of transmitting MSGA.

Moreover, the network may semi-statically determine radio resources, to be used for performing the 2-step RACH procedure and the 4-step RACH procedure, that are exclusive from one another. The radio resources used for transmitting the first message in the RACH procedure include at least the RACH occasion as well as the preambles. For instance, in the 2-step RACH procedure, the first message msgA uses not only the PRACH resource (e.g. the RACH occasion and preamble) but also the associated PUSCH resources.

### UE Identifications

RNTI stands for Radio Network Temporary Identifier. For instance, an RNTI can used to differentiate and identify a UE in the radio cell. Further, an RNTI can also identify a specific radio channel, a group of UEs in case of paging, a group of UEs for which power control is issued by the eNB, system information transmitted for all the UEs by 5G base-station (gNB). 5G NR defines numerous different identifications for the UE, some of which are presented in the following table (see 3GPP TS 38.321 v15.8.0, section 7.1).

| | | Transport | Logical |
|---|---|---|---|
| NTI | Usage | Channel | Channel |
| P-RNTI | Paging and System Information | PCH | PCCH |
| | change notification | | |
| SI-RNTI | Broadcast of System | DL-SCH | BCCH |
| | Information | | |
| RA-RNTI | Random Access Response | DL-SCH | N/A |
| Temporary | Contention Resolution (when no | DL-SCH | CCCH, |
| C-RNTI | valid C-RNTI is available) | | DCCH |
| Temporary | Msg3 transmission | UL-SCH | CCCH, |
| C-RNTI | | | DCCH, |
| | | | DTCH |
| C-RNTI, MCS- | Dynamically scheduled unicast | UL-SCH | DCCH, |
| C-RNTI | transmission | | DTCH |
| C-RNTI | Dynamically scheduled unicast | DL-SCH | CCCH, |
| | transmission | | DCCH, |
| | | | DTCH |
| MCS-C-RNTI | Dynamically scheduled unicast | DL-SCH | DCCH, |
| | transmission | | DTCH |
| C-RNTI | Triggering of PDCCH ordered | N/A | N/A |
| | random access | | |
| CS-RNTI | Configured scheduled unicast | DL-SCH, | DCCH, |
| | transmission (activation, | UL-SCH | DTCH |
| | reactivation and retransmission) | | |
| CS-RNTI | Configured scheduled unicast | N/A | N/A |
| | transmission (deactivation) | | |
| TPC-PUCCH- | PUCCH power control | N/A | N/A |
| RNTI | | | |
| TPC-PUSCH- | PUSCH power control | N/A | N/A |
| RNTI | | | |
| TPC-SRS-RNTI | SRS trigger and power control | N/A | N/A |
| INT-RNTI | Indication pre-emption in DL | N/A | N/A |
| SFI-RNTI | Slot Format Indication on the | N/A | N/A |
| | given cell | | |
| SP-CSI-RNTI | Activation of Semi-persistent | N/A | N/A |
| | CSI reporting on PUSCH | | |

NOTE:
The usage of MCS-C-RNTI is equivalent to that of C-RNTI in MAC procedures (except for the C-RNTI MAC CE).

Apart from the above-identified RNTIs, there can be further IDs, such as the Inactive-RNTI (I-RNTI) (see TS 38.331 v15.8.0 e.g. section 6.3.2). The Inactive-RNTI is used for a UE in the RRC_INACTIVE state and for example in the process of identifying and locating the suspended UE context of that UE. According to one implementation, the network assigns the I-RNTI when the UE moves (e.g. from RRC_CONNECTED) to the RRC_INACTIVE state (e.g. as part of the RRCRelease message within SuspendConfig). There are two types of I-RNTIs, namely the full I-RNTI and the short I-RNTI. The network can inform the UE (e.g. as part of SIB1, System Information Block 1), which I-RNTI to use when resuming the connection. The full I-RNTI is a bit string of length 40 bits, while the short I-RNTI is a bit string of length 24 bits.

### RRC States (RRC_Connected, RRC_Inactive)

In LTE, the RRC state machine consisted of only two states, the RRC idle state, mainly characterized by high power savings, UE autonomous mobility and no established UE connectivity towards the core network, and the RRC connected state in which the UE can transmit user plane data while mobility is network-controlled to support lossless service continuity. In connection with 5G NR, the LTE-related RRC state machine may also be extended with an inactive state (see e.g. TS 38.331 v15.8.0, FIG. 4.2.1-2), similar to the NR 5G as explained in the following.

The RRC in NR 5G (see TS 38.331 v15.8.0, section 4) supports the following three states, RRC Idle, RRC Inactive, and RRC Connected. A UE is either in RRC_CONNECTED state or in RRC_INACTIVE state when an RRC connection has been established. If this is not the case, i.e. no RRC connection is established, the UE is in RRC_INACTIVE state. The following state transitions are possible:
from RRC_INACTIVE to RRC_CONNECTED, following e.g. the “connection establishment” procedure;
from RRC_CONNECTED to RRC_IDLE, following e.g. the “connection release” procedure;
from RRC_CONNECTED to RRC_INACTIVE, following e.g. the “connection release with suspend” procedure;
from RRC_INACTIVE to RRC_CONNECTED, following e.g. the “connection resume” procedure;
from RRC_INACTIVE to RRC_IDLE (uni-directional), following e.g. the “connection release” procedure.

The new RRC state, RRC Inactive, is defined for the new radio technology of 5G 3GPP, so as to provide benefits when supporting a wider range of services such as the eMBB (enhanced Mobile Broadband), mMTC (massive Machine Type Communications) and URLLC (Ultra-Reliable and Low-Latency Communications) which have very different requirements in terms of signalling, power saving, latency etc. The new RRC Inactive state shall thus be designed to allow minimizing signaling, power consumption and resource costs in the radio access network and core network while still allowing e.g. to start data transfer with low delay.

According to an exemplary 5G NR implementation, the different states are characterized as follows (see section 4.2.1 of TS 38.331):

RRC_IDLE:
A UE specific DRX may be configured by upper layers;
UE controlled mobility based on network configuration;
The UE:
Monitors Short Messages transmitted with P-RNTI over DCI (see clause 6.5);
Monitors a Paging channel for CN paging using 5G-S-TMSI;
Performs neighbouring cell measurements and cell (re-) selection;
Acquires system information and can send SI request (if configured).

RRC_INACTIVE:
A UE specific DRX may be configured by upper layers or by RRC layer;
UE controlled mobility based on network configuration;
The UE stores the UE Inactive AS context;
A RAN-based notification area is configured by RRC layer;

### The UE:

Monitors Short Messages transmitted with P-RNTI over DC! (see clause 6.5);
Monitors a Paging channel for CN paging using 5G-S-TMSI and RAN paging using full I-RNTI;
Performs neighbouring cell measurements and cell (re-) selection;
Performs RAN-based notification area updates periodically and when moving outside the configured RAN-based notification area;
Acquires system information and can send SI request (if configured).

RRC_CONNECTED:
The UE stores the AS context;
Transfer of unicast data to/from UE;
At lower layers, the UE may be configured with a UE specific DRX;
For UEs supporting CA, use of one or more SCells, aggregated with the SpCell, for increased bandwidth;
For UEs supporting DC, use of one SCG, aggregated with the MCG, for increased bandwidth;
Network controlled mobility within NR and to/from E-UTRA;
The UE:
Monitors Short Messages transmitted with P-RNTI over DC! (see clause 6.5), if configured;
Monitors control channels associated with the shared data channel to determine if data is scheduled for it;
Provides channel quality and feedback information;
Performs neighboring cell measurements and measurement reporting;
Acquires system information.”

According to the characteristics of the RRC Inactive state, for the Inactive UE the connection both for user plane and control plane is maintained with RAN and the core network. More specifically, in RRC Inactive, although the connection still exists, it is suspended, or put differently the connection is not active anymore. On the other hand, in RRC Connected state, the connection exists and is active, e.g. in the sense that it is used for a data transmission. In RRC Idle state, the UE has no RRC connection with the RAN and the core network, which also means that e.g. the radio base station does not have any context of the UE and e.g. does not know the identification of the UE and does not have security parameters relating to the UE to be able to properly decode data transmitted by the UE (security e.g. ensures integrity of the transmitted data). UE context may be available in the core network, but would have to be fetched first by the radio base station.

In addition, the paging mechanism (may also be called e.g. notification mechanism) for user equipments in that radio cell is based on so called radio access network, RAN, based notification areas (in short RNAs). The radio access network should be aware of the current RNA the user equipment is located in, and the user equipment may assist the base-station (gNB) to track the UE moving among various RNAs. The RNA can be UE-specific.

One example of a subsequent RRC connection release procedure to transition to the RRC Inactive state (see TS 38.331 v15.8.0 section 5.3.8) is explained in the following.

The purpose of this procedure is to release the RRC connection or to suspend the RRC connection. For instance, the network initiates the RRC connection release procedure to transit a UE in RRC_CONNECTED to RRC_IDLE or to RRC_INACTIVE. The actions the UE performs for the RRC Connection Release procedure, disclosed in section 5.3.8.3 of TS 38.331, include suspending all SRB(s) (Signaling Radio Bearers) and DRB(s) (Data Radio Bearers) except SRB0, in case the release is done with suspend (e.g. “RRCRelease includes suspendConfig”). Correspondingly, the UE in RRC Inactive state does not have any non-suspended or active DRB (only suspendedDRBs). SRB0, which is kept active, even in RRC_INACTIVE state, can be used by the UE e.g. for performing the RACH procedure, e.g. when carrying RRC messages, such as the RRCResumeRequest, RRCResumeRequest1, RRCSetupRequest.

In an exemplary implementation in 5G NR, signaling radio bearers (see TS 38.331 v15.8.0 section 4.2.2) are defined as radio bearers that are used only for the transmission of RRC and NAS messages, and may include SRB0 (for RRC messages using the CCCH logical channel), SRB1, SRB2, and SRB3. In an exemplary implementation in 5G NR (see TS 38.300 v16.0.0 section 12.1), the NG-RAN establishes at least one DRB together with the PDU Session, and additional DRB(s) for QoS flow(s) of that PDU session can be subsequently configured. The NG-RAN then maps packets belonging to different PDU sessions to different DRBs. NG-RAN and 5GC ensure quality of service (e.g. reliability and target delay) by mapping packets to appropriate QoS Flows and DRBs. Put differently, a DRB is used to carry user data associated with a PDU session.

An overview of how radio bearers are defined in relation to logical channel, transport channels and different QoS flows respectively for downlink and uplink can be found in 3GPP TS 38.300 v16.0.0, section 6.1, where you find the Layer 2 architecture for downlink and uplink, describing:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp refers to header compression and segm. to segmentation;
Control channels (BCCH, PCCH are not depicted for clarity).

Radio bearers are categorized into two groups: data radio bearers (DRB) for user plane data and signalling radio bearers (SRB) for control plane data.

### Small-Data Transmissions

The characteristics of the small-data transmissions that are targeted in this disclosure refer to any service with the characteristics that data bursts in UL/DL are small and optionally rather infrequent with no strict requirements on delay. Typical non-limiting examples of traffic characteristics are captured in the following table (see TR 25.705 v13.0.0 section 5).

### Characteristics of the Small-Data Transmissions

| Traffic parameter | Value |
|---|---|
| application packet size | 100 bytes (UL); 100 bytes (DL) |
| latency1 | 5 s to 30 min; 1 hour for no mobility (static, |
| | pedestrian) |
| frequency | every minute and up to monthly |

NOTE 1:
latency is the duration from when the packet arrives at the buffer until it is completely transmitted (delay tolerance of the application).

### Small-Data Transmission by UE in RRC Inactive State

The present embodiments provide a procedure that allows a UE in the RRC Inactive state to transmit data e.g. small data, more particularly without the need to change the UE state.

In more detail, 5G NR supports the RRC_INACTIVE state, and UEs with infrequent (periodic and/or non-periodic) data transmission are generally maintained by the network in the RRC_INACTIVE state. Until Rel-16, the RRC_INACTIVE state does not support data transmission. Hence, the UE has to resume the connection, e.g. move to RRC_CONNECTED state for any DL (MobileTerminated) and UL (MobileOriginated) data. Connection setup (or resume) and subsequently release to INACTIVE state happens for each data transmission, however small and infrequent the data packets are. This results in unnecessary power consumption and signalling overhead.

Specific examples of small and infrequent data traffic include the following use cases:

Smartphone applications:
Traffic from Instant Messaging services (whatsapp, QQ wechat etc.)
Heart-beat/keep-alive traffic from IM/email clients and other apps
Push notifications from various applications

Non-smartphone applications:
Traffic from wearables (periodic positioning information etc.)
sensors (Industrial Wireless Sensor Networks transmitting temperature, pressure readings periodically or in an event triggered manner etc.)
smart meters and smart meter networks sending periodic meter readings

A exemplary procedure of the prior art, which is in this case a 5G NR compliant prior art solution, to enable a UE in the RRC Inactive state to transmit (small) data will be briefly explained. The UE is assumed to be in RRC_Inactive, which involves that the UE and base-station (gNB) has all data radio bearers suspended, and no data can be transmitted to the base-station (gNB). In order to enable the UE to transmit data, the UE has to be first transitioned into the RRC Connected state, which can be done by the UE requesting to resume the RRC connection (here transmitting RRCResumeRequest) as part of the RACH procedure e.g. using the 4-step RACH procedure. In detail, the UE may transmit the preamble to the current gNB, then received a corresponding random access response (with a small UL grant of radio resources), which are used by the UE to transmit the RRCResumeRequest message as msg3 of the RACH procedure.

It is assumed that the UE moved to a new base-station (gNB) from its previous Anchor base-station (gNB). Thus, the new base-station (gNB) does not yet have the suitable contexts for the UE, which have to be retrieved first from the Anchor base-station (gNB).

Finally, the new base-station (gNB) provides the RRCResume message to the UE, which then transitions to the RRC Connected state, including the resumption of all data radio bearers. In RRC_Connected state the UE is then able to transmit the UL data.

Transitioning to the connected state before the UE can send any user data introduces latency and consumes significant UE power for each transmission of user data.

Moreover, signalling overhead from INACTIVE state UEs for small data packets is a general problem and will become a critical issue with more UEs in 5G NR not only for network performance and efficiency, but also for the UE battery performance. In general, any device that has intermittent small data packets in INACTIVE state will benefit from enabling small-data transmission in the INACTIVE state.

In 3GPP, no final agreements have been reached as a standardized method on how the transmission of (small) data can be enabled for a UE that stays in the RRC Inactive state. The embodiments identify the possibility of completing and/or improving the mechanism and procedures involved for enabling a UE to transmit data when in RRC Inactive state.

The task is to overcome the cited and described problems concerning that when DL small data transmission is ongoing, and if in the middle of that, UE wants to initiate UL data transmission, which can be either UL small data or UL non-small data, then the current UE behavior and procedure is will be set to a defined state.

The proposed solution is provided in FIG. 3.

FIG. 4 illustrates the configuration of one random-access channel (RACH) resources per Synchronization Signal Block (SSB) by base-station (gNB)

Generally spoken when Network (NW) is congested, collision among user equipments (UEs) would increase and would result in RACH procedure failure. As a consequence signaling overhead as well as power consumption would increase for SDT UE. SS Block (SSB) stands for Synchronization Signal Block and in reality it refers to Synchronization/PBCH block because Synchronization signal and PBCH channel are packed as a single block that always moves together. The components of this block are as follows:

### Synchronization Signal:

PSS (Primary Synchronization Signal), SSS (Secondary Synchronization Signal)

### PBCH:

PBCH DMRS and PBCH (Data)

This is just two major components of SS Block and it carries a lot of details.

Each SSB has an index with an increasing number from 0 to Lmax. −1. The periodicity (20 ms) can vary between 5 ms and 160 ms (5, 10, 20, 40, 80, 160 ms). The 3GPP standard recommends using a periodicity of 20 ms for cell-defining SSBs. Higher periodicities such as 80 ms or 160 ms are preferably used for SSBs in mmWave networks in order to allow more time for the transmission of a higher number of SSBs.

To reduce the signaling overhead, the base station (gNB) can schedule the downlink transmission without entailing the user equipment (UE) to be in the connected state. For this purpose, the user equipment (UE) can be scheduled with the predefined cell and beam, used for the earlier transmissions. Such information user equipment (UE) can receive either in dedicated RRC message or paging message

If the user equipment (UE) determines its current beam position is aligned with the preconfigured cells/beams, it doesn't trigger RA-SDT or CG-SDT. The user equipment (UE) will receive DL data after the configured time expires over the predefined cells/beams.

For the following description of the improved procedures for transmission of data for a user equipment (UE) in the RRC Inactive state, focus is made on transmission of small data as defined before in connection with the 5G NR study items and agreements. However, the embodiments should not be limited thereto, but should also be applicable, following the same principles lined out below for a small-data transmission, when intending to transmit more or other data than typically considered small data.

In the following, user equipment (UEs), base stations (gNB), and procedures to meet these needs will be described for the new radio access technology envisioned for the 5G or 6G mobile communication systems, but which may also be used in LTE mobile communication systems. Different implementations and variants will be explained as well. The following disclosure was facilitated by the discussions and findings as described above and may for example be based at least on part thereof.

In general, it should be noted that many assumptions have been made herein so to be able to explain the principles underlying the present disclosure in a clear and understandable manner. These assumptions are however to be understood as merely examples made herein for illustration purposes that should not limit the scope of the disclosure. A skilled person will be aware that the principles of the following disclosure and as laid out in the claims can be applied to different scenarios and in ways that are not explicitly described herein.

Moreover, some of the terms of the procedures, entities, layers etc. used in the following are closely related to LTE/LTE-A systems or to terminology used in the current 3GPP 5G standardization, even though specific terminology to be used in the context of the new radio access technology for the next 3GPP 5G communication systems is not fully decided yet or might finally change. Thus, terms could be changed in the future, without affecting the functioning of the embodiments.

Consequently, a skilled person is aware that the embodiments and their scope of protection should not be restricted to particular terms exemplarily used herein for lack of newer or finally agreed terminology but should be more broadly understood in terms of functions and concepts that underlie the functioning and principles of the present disclosure.

For instance, a mobile station or mobile node or user terminal or user equipment (UE) is a physical entity (physical node) within a communication network. One node may have several functional entities. A functional entity refers to a software or hardware module that implements and/or offers a predetermined set of functions to other functional entities of the same or another node or the network. Nodes may have one or more interfaces that attach the node to a communication facility or medium over which nodes can communicate. Similarly, a network entity may have a logical interface attaching the functional entity to a communication facility or medium over which it may communicate with other functional entities or correspondent nodes.

The term “base station” or “radio base station” here refers to a physical entity within a communication network. As with the mobile station, the base station may have several functional entities. A functional entity refers to a software or hardware module that implements and/or offers a predetermined set of functions to other functional entities of the same or another node or the network. The physical entity performs some control tasks with respect to the communication device, including one or more of scheduling and configuration. It is noted that the base station functionality and the communication device functionality may be also integrated within a single device. A mobile terminal may implement also functionality of a base station for other terminals. The terminology used in LTE is eNB (or eNodeB), while the currently used terminology for 5G NR is gNB-base-station (gNB).

The term “data connection” used herein can be understood as connection over which a transmission of data, e.g. small data, is possible, e.g. between a user equipment (UE) and a radio base-station. In more detail, a user equipment (UE) without a data connection, e.g. even if connected with the radio base station based on a signaling connection, cannot immediately transmit data. Data in this context can be understood broadly as user data, e.g. from an application running on the user equipment (UE), in contrast to e.g. control information which would be rather transmitted using a signaling connection.

In one exemplary implementation, according to the 5G NR standard, the data connection can be understood as a data radio bearer, DRB, and the signaling connection can be understood as a signaling radio bearer, SRB.

In some instances, the present application further distinguishes between different conditions of a data connection, e.g. non-existent, existent but suspended, existent but not used could also be termed non-suspended or inactive, existent and currently used to transmit data could also be termed active. Following this categorization of the data connection, a suspended data connection, although it exists, cannot be used immediately to transmit data in the uplink (UL), because it is suspended by both endpoints, e.g. the UE and the radio base station and needs to be resumed first. On the other hand, a non-suspended data connection may allow an immediate data transmission, e.g. without any further procedure such as resuming the data connection.

For example, when referring to an exemplary 5G NR implementation as currently defined in the 3GPP standards, the UE in the RRC Inactive state will have one or more suspended data connections (DRBs are suspended); the UE in the RRC Connected state may have one or more active data connections and possibly other non-suspended data connections, that are currently not actively used; and the UE in the RRC Idle state will not have a data connection neither suspended nor active. On the other hand, according to the improved data transmission procedure explained in the following, different from the currently defined 5G NR implementation in the 3GPP standards, the UE in the RRC Inactive state will have one or more non-suspended data connections available these will be inactive because no data is being exchanged, until the small data transmission.

In this context, the present application explains that a data connection is used e.g. by the UE to transmit the small data. In the present scenarios, the data connection is established between the UE and the base station. In one exemplary implementation, a data connection is to be broadly understood as being associated with certain parameters, relating to coding, security, encryption etc. Thus, from the transmitting side perspective, the UE applies these parameters associated with that data connection to the (small) data to be transmitted using this data connection. This may be done e.g. to ensure a particular Quality of Service. Correspondingly, from the receiving side perspective, the receiver may need to apply the converse processing (e.g. relating to coding, security, encryption, etc.) as in the transmitting side, so as to successfully decode the data transmitted via the data connection.

FIG. 4 illustrates a general, simplified and exemplary of a user equipment, also termed communication device and a scheduling device here exemplarily assumed to be located in the base station, e.g. the eLTE eNB alternatively termed ng-eNB or the base-station (gNB) in 5G NR. The UE and eNB/gNB are communicating with each other over a (wireless) physical channel respectively using the transceiver.

The communication device may comprise a transceiver and processing circuitry. The transceiver in turn may comprise and/or function as a receiver and a transmitter. The processing circuitry may be one or more pieces of hardware such as one or more processors or any LSIs. Between the transceiver and the processing circuitry there is an input/output point (or node) over which the processing circuitry, when in operation, can control the transceiver, i.e. control the receiver and/or the transmitter and exchange reception/transmission data. The transceiver, as the transmitter and receiver, may include the RF (radio frequency) front including one or more antennas, amplifiers, RF modulators/demodulators and the like. The processing circuitry may implement control tasks such as controlling the transceiver to transmit user data and control data provided by the processing circuitry and/or receive user data and control data, which is further processed by the processing circuitry. The processing circuitry may also be responsible for performing other processes such as determining, deciding, calculating, measuring, etc. The transmitter may be responsible for performing the process of transmitting and other processes related thereto. The receiver may be responsible for performing the process of receiving and other processes related thereto, such as monitoring a channel. An improved data transmission procedure will be described in the following. In said connection, an improved UE is presented which participates in the improved data transmission procedure. Furthermore, an improved radio base station is presented which participates in the improved data transmission procedure. Corresponding methods for the UE behavior and the base station behavior are provided as well.

FIG. 5 shows one base-station (gNB) configures more than one random-access channel (RACH) resources per Synchronization Signal Block (SSB). A base-station (gNB) configures more than one RACH resources per SSB. A mapping of the RACH resources is based on the one of following possible options:
Opt1: priority (P1)
   P1→RACH resources 1
   P2→RACH resources 2
   P3→RACH resources 3
Opt2: group ID
   group ID1→RACH resources 1
   group ID2→RACH resources 2
   group ID3→RACH resources 3

The above mentioned mapping is done through either system Information or dedicated RRC message. The base-station (gNB) indicates priority/group ID in the paging message and user equipment (UE) selects random-access channel (RACH) resources accordingly. The base-station (gNB) can change number of random-access channel (RACH) resources based on overall load situation.

As an example if base-station (gNB) indicates priority P1 in the paging message then user equipment (UE) selects RACH resources 1 to perform RACH procedure.

Similarly, if base-station (gNB) indicates group ID3 in the paging message then UE selects random-access channel (RACH) resources 3 to perform random-access channel (RACH) procedure

FIG. 5 illustrates also a simplified and exemplary user equipment (UE) structure according to one exemplary solution of the improved data transmission procedure and can be implemented based on the general user equipment (UE) structure explained in connection with FIG. 4. The various structural elements of the user equipment (UE) illustrated in FIGS. 4 and 5 can be interconnected between one another e.g. with corresponding input/output nodes (not shown) e.g. in order to exchange control and user data and other signals. Although not shown, the user equipment (UE) may include further structural elements. The user equipment (UE) may include transmission-data-determining circuitry, user equipment (UE)-identification determining circuitry as well as a corresponding non-cell-specific user equipment (UE) ID and a cell-specific user equipment (UE) ID, and a control-message and small-data transmitter.

In the present case as will become apparent from the below disclosure, the processing circuitry can thus be exemplarily configured to at least partly perform one or more of determining that a small-data transmission is to be performed, of determining which UE identification to use for the small-data transmission, of determining one of the non-cell-specific UE ID and cell-specific UE ID, etc.

The transmitter can thus be exemplarily configured to at least partly perform one or more of transmitting the small data and transmitting the selected UE ID, etc.

A processor of the UE determines that a transmission of small data is to be performed. It is exemplarily assumed that the UE is in an inactive state with at least one active data connection to a radio base station that controls a radio cell in which the UE is located. The UE is assigned at least with a cell-specific UE identification and a non-cell-specific UE identification. The processor determines which UE identification to use for the small-data transmission, based on whether the UE, after having transitioned to the inactive state, has moved to the current radio cell from another radio cell. In case the UE has moved to the current radio cell from another radio cell, the processor determines to use the non-cell-specific UE identification for the small-data transmission. In case the UE has not moved to the current radio cell from another radio cell, the processor determines to use the cell-specific UE identification for the small-data transmission. A transmitter of the UE transmits a control message including the determined UE identification and transmits the small data using one of the at least one data connection.

### FIG. 6 Shows the Provided the Flow Chart for User Equipment (UE) Side

The User equipment (UE) receives priority or group ID indication from base-station (gNB). After this reception the user equipment (UE) selects the random-access channel (RACH) resources corresponding to priority or group ID.

When user equipment (UE) receives paging message, it provides current beam location to base station (gNB). Afterward, base station (gNB) schedules DL small data transmission to indicate beam by user equipment (UE). For example user equipment (UE) reports beam 3 upon when it receives paging message from base station (gNB).

According to this data transmission procedure discussed herein, the UE has at least one data connection also when being in the inactive state, which can then be used in the subsequent procedure to transmit the data to the radio base station.

According to one exemplary implementation, the corresponding radio base station also maintains the data connection, when the UE moves into the inactive state.

Furthermore, the UE may have several identifications, such as a cell-specific UE ID and a non-cell-specific UE ID. The cell-specific UE ID can be assigned by a radio base station in which the UE is located and is primarily usable in that radio cell. When the UE moves between different radio cells, each radio base station, controlling the respective radio cell, may assign a different cell-specific UE ID to the UE. In addition, according to one example, the cell-specific UE ID can also be specific to small-data transmissions, such that it is to be used by the UE (and BS) in relation to a small data transmission but not for other types of data transmissions. Alternatively, or in addition, the cell-specific UE ID may be specific to the inactive state of the UE, such that it is to be used by the UE when in an inactive state, but not e.g. when the UE is in the connected state or the idle state.

On the other hand, the non-cell-specific UE ID can be assigned e.g. by a base-station (gNB), in which radio cell the UE is located or by an entity of the core network (such as the Access and Mobility Management Function, AMF) and may be valid in a bigger geographical area than a radio cell, such as a Public Land Mobile Network, PLMN. In one exemplary implementation, the non-cell-specific UE ID may include an identification of the radio base station and an identification of the UE. In addition, according to another example, the non-cell-specific UE ID may be specific to the inactive state of the UE, such that it is to be used by the UE when in an inactive state, but not e.g. when the UE is in the connected state or the idle state.

Typically, cell-specific UE IDs are shorter than non-cell-specific UE IDs, because cell-specific UE IDs only need to respectively distinguish UEs being located in a same radio cell whereas non-cell-specific UE IDs need to distinguish many more UEs than those being located in one radio cell.

At some point of time while the UE is in the inactive state, it is assumed that small data becomes available for transmission such that the UE determines that a small-data transmission is to be performed. The small-data transmission also involves determining which UE identification to use. This is performed by the UE based on the current radio cell in which the UE is located and more specifically based on whether the UE, after having transitioned to the inactive state, has moved to the current radio cell from another radio cell or not. Put differently, determining which UE ID to use for the small-data transmission depends on whether or not the current radio cell of the UE is the same radio cell as when transitioning to the current inactive state. For instance, the UE, which was in radio cell A when it transitioned to the inactive state, may move between radio cells and may now be in another radio cell B when small data becomes available for transmission.

Although in this exemplary improved data transmission procedure, the current radio cell will be the main basis for determining which UE identification to use for the small-data transmission, other variants and implementations of the improved data transmission procedure may use alternative or additional information as basis.

According to the UE behavior as exemplified in FIG. 16, the UE determines the non-cell-specific UE ID when it has determined that the UE has moved to the current radio cell from another radio cell, e.g. the UE changed radio cell while in inactive state. Conversely, the UE determines the cell-specific UE ID when it has determined that the UE has not moved to the current radio cell from anther radio cell, e.g. the UE stayed in the same radio cell while in inactive state.

After having decided on the UE ID, the UE may then proceed to perform the small-data transmission, which includes transmission of a control message including the determined UE ID as well as includes the transmission of the small data itself. The transmission of the small data can use one of the at least one non-suspended data connections that are available for the UE in the inactive state.

It is possible for a UE that is in the inactive state to perform the transmission of data without having to transition to the connected state. This facilitates avoiding the above-mentioned disadvantages. In particular, the data transmission procedure facilitates avoiding delays, saving significant UE power and reducing the data overhead resulting from the state transition necessary in the prior art.

Moreover, the improved data transmission procedure appropriately selects the UE ID for the small-data transmission. In particular, the cell-specific UE ID, which is shorter than the non-cell-specific UE ID, is selected when the UE stayed in the same radio cell and thus the radio base station still knows the cell-specific UE ID. In the prior art, the UE might have used the non-cell-specific UE ID irrespective of which radio cell the UE is currently located in. Thus, the data transmission procedure benefits from using the shorter cell-specific UE ID when useful and thus has to transmit less data bits. On the other hand, the improved data transmission ensures that the radio base station in which the UE is located can properly identify the UE by using the non-cell-specific UE ID, when the UE has moved to another radio cell.

FIG. 7 Shows the Provided the Flow Chart for Base-Station (gNB) Side

The base-station (gNB) configures more than one (RACH) resources. After this step base-station (gNB) provides mapping between priority and/or group ID and (RACH).

The base station may include a control-message and small-data receiver, and a small-data decoding processing circuitry. In the present case as will become apparent from the below disclosure, the processing circuitry can thus be exemplarily configured to at least partly perform one or more of decoding small data, etc. The receiver can thus be exemplarily configured to at least partly perform one or more of receiving the small data and the control message, comprising the UE ID.

The radio base station comprises a receiver, which receives, from a user equipment, UE, a control message including a UE identification. The receiver also receives, from the UE, small data using a data connection established with the UE. The UE is in an inactive state, wherein the UE identification is either a cell-specific UE identification or a non-cell-specific UE identification. A processor decodes the small data, using a UE context associated with the UE and the one data connection.

Correspondingly, the radio base station facilitates receiving small data from a UE in the inactive state, without having to transition the UE to the connected state, thus facilitating to avoid the disadvantages related therewith. The UE uses a corresponding data connection in the inactive state to transmit the data to the base station, and the base station receives and decodes the small data using the corresponding data connection at the base station side. According to one exemplary solution, also the base station maintains a data connection with the UE, when the UE is in the inactive state, so as to be able to properly receive and decode the small data.

The improved base station according to FIG. 7 that participates in the improved data transmission procedure can be, 1) the same old radio base station to which the UE was already connected when being in the inactive state (in short, old BS case), or 2) a new radio base station, to which the UE moved from the previous radio base station while being in the inactive state (in short, new BS case). Part of the behavior of the improved radio base station depends on whether the base station is the same old base station or a new base station.

It is exemplarily assumed that the UE is initially in a connected state with at least one data connection established between the UE and the base station. Eventually, the base station decides to transition the UE into the inactive state, and correspondingly provides an instruction in said respect to the UE, which follows the instruction and transitions to the inactive state. As explained before, the UE when in the inactive state will also have a data connection available.

It is assumed that eventually small data becomes available for transmission according to FIG. 6. The UE checks, whether an indication of one-shot downlink (DL) data transmission is received. If the check results in, that there is an indication is given, the UE send an uplink (UL) data after finishing downlink (DL) date transmission. In line with the improved data transmission procedure, the UE determines which UE ID to transmit with the small data. In said respect, it concludes that it is still located in the same radio cell as when being in the inactive state (i.e. no radio cell change occurred while in inactive state). Thus, the UE selects the cell-specific UE ID, which was assigned by the current base station. The base station thus is able to unambiguously identify the UE based on the cell-specific UE ID. The UE then transmits a corresponding control message, including the selected cell-specific UE ID, and transmits the small data using the data connection. In one example, the control message and small data are transmitted together to the base station, wherein the data connection is not necessarily used for transmitting the control message with the cell-specific UE ID. For instance, the control message and small data are transmitted together in the same transport block but using a signaling connection for the control message and a data connection for the data.

In relation to the case in which a radio cell change occurred during the inactive state of the UE. In the same manner, the UE is initially in a connected state with at least one data connection established between the UE and the base station. Eventually, the base station decides to transition the UE into the inactive state, and correspondingly provides an instruction in said respect to the UE, which follows the instruction and transitions to the inactive state. As explained before, the UE when in the inactive state will also have a data connection available to the (old) base station.

In the inactive state, it is assumed here that the UE moves from the old base station to the radio cell of a new base station. After the radio cell change, it is further assumed that small data eventually becomes available for transmission, and the UE proceeds to perform the data transmission procedure discussed in FIG. 5. Correspondingly, the UE concludes that it is located in a radio cell that is different from the radio cell it was located in when transitioning to the inactive state. Thus, in line with the UE behavior discussed above, the UE selects the non-cell-specific UE ID, which is such that the base station can unambiguously identify the UE. The UE transmits the corresponding control message, including the selected non-cell-specific UE ID, and transmits the small data using the data connection.

However, from the perspective of the new base station, no data connection exists yet with the UE, because the UE was previously connected with the old base station, not with the new base station. In order to decode the small data, the new base station can contact the old base station to retrieve the corresponding context(s) of the UE. The old base station can be determined from the non-cell-specific UE ID received in the control message. The new base station may transmit a request for retrieving the UE context to the old BS, and in return may receive from the old base station a response that includes the requested UE context(s). Typically, the UE context includes information such as coding, security and encryption parameters associated with the UE and a data connection that can be used for decoding the small data.

The above presented radio base station operates together with the UE to perform the improved data transmission procedure. The control message received from the UE may include a UE ID, either being a cell-specific UE ID or a non-cell-specific UE ID. The cell-specific UE ID is an ID that was assigned by a radio base station for identifying a UE in its radio cell, for instance by the radio base station to which the UE now transmits the small data or by another radio base station, to which the UE was previously connected and was thus assigned with a cell-specific UE ID.

According to another exemplary variant of the data transmission procedure, which can be combined with other variants and implementations of the improved data transmission procedure, a new timer is operated for the cell-specific UE ID as will be explained. The radio base station that assigned the cell-specific UE ID to the UE needs to reserve the cell-specific UE ID for the UE, and thus cannot use same for identifying another UE. Since the cell-specific UE IDs are typically short around 16 bits, there may be the problem that there are not enough cell-specific UE IDs to be assigned to UEs that are or were connected to the base station. Therefore, a UE-I D-validity timer can be operated by the UE and the base station to set a time period as the limit during which the cell-specific UE ID is being reserved by the base station for the UE, after it is not being actively used by the UE because the UE is in the inactive state.

According to one exemplary implementation of the variant, the new UE-ID validity timer can be started when the UE transitions into the inactive state generally.

The period of the new UE-ID validity timer can be for instance determined by the base station and then informed to the UE, e.g. in a control message, such as a RRC message. The determination of the base station may for instance depend on the number of unreserved cell-specific UE IDs that are still available for being assigned to UEs. For instance, the new UE-ID validity timer can be configured to expire, after 1024 seconds; but other values for the timer may be equally possible. Alternatively, the value of the UE-ID validity timer can be fixed by a corresponding 3GPP standard, and can be hard-coded into the UE and base station.

After the UE-I D-validity timer expires for a particular cell-specific UE ID, the base station considers this expired cell-specific UE ID to no longer be associated with the UE but considers same to be available to be newly assigned to another UE. Thus, after expiry, the base station would not be able to identify the UE based on the expired cell-specific UE ID.

Conversely, the UE also operates the UE-ID-validity timer, preferably in synchronization with the base station, in order to know when the cell-specific UE ID expires at the base station side. An expired cell-specific UE ID should not be used by the UE when contacting the base station, because the base station will no longer have that expired cell-specific UE ID associated with the correct UE.

This variant of the data transmission procedure, using the new UE-ID-validity timer, provides cell-specific UE IDs are only blocked for a limited configurable amount of time by UEs that transition into inactive state. On the other hand, by still allowing the cell-specific UE ID to be valid for some time, the UE may use the cell-specific UE ID for procedures with the base station, such as the data transmission procedure discussed herein.

As a result, other variants of the data transmission procedure take the new UE-ID-validity timer into account, as will become apparent from the following. In particular, the UE behavior for determining the suitable UE ID to be transmitted together with the small data may depend on the UE-ID-validity timer.

This implementation differs in the additional process of starting the UE-ID-validity timer for the cell-specific UE ID, and by the additional check as to whether the UE-ID-validity timer has expired or not for the cell-specific UE ID. In short, the cell-specific UE ID is not to be used when the ID has expired, e.g. when the corresponding UE-ID-validity timer has expired. In said case, even though the UE is still located in the same radio cell as when transitioning into the inactive state, this means no, same old radio cell-case, the UE will select the non-cell-specific UE ID.

The sequence of checks to determine with UE ID to select based on both the current radio cell and the UE-ID-validity timer are possible examples and different implementations are equally possible.

For instance, the UE might first check whether the UE-ID-validity timer expired for a cell-specific UE ID and then check whether it is located in the same old radio cell or a new radio cell. In a still different implementation, the UE may first check whether the UE-ID-validity timer expired for a cell-specific UE ID. Then, in case the UE-ID-validity timer expired, the UE may directly determine to use the non-cell-specific UE ID without the need to further check whether the UE is located in the same old radio cell or a new radio cell.

According to a further embodiment of the new UE-ID-validity variant of the data transmission procedure, the timer can be restarted by the UE after the UE receives a response from the base station, relating to the small-data transmission. The same timer can be restarted by the base station after the base station responds to the small data transmission performed by the UE. This restarting of the timer can thus prolong the validity time, in case the UE transmits small data.

According to a further variant of the data transmission method, the control message, which already includes the UE ID, may further include an indication that small data is being transmitted together with the control message. This facilitates that the base station properly receives and decodes the small data, transmitted by the UE. Otherwise, the base station might not expect the small data and will not perform the corresponding processing to decode the small data. This variant is characterized in such a way, as the control message is illustrated as including a small-data indication. In one example, the small-data indication can be one bit.

More specific implementations of the small-data indication are explained later in connection with a 5G NR based implementation of the improved data transmission procedure see small-data cause and small-data indication in RRC message and MAC message.

Alternatively, another variant of the improved data transmission method does not have to rely on the small-data indication in the control message. In said variant, where no corresponding small-data indication is used in the control message, the base station may always be prepared that small data is being transmitted together with the control message from the UE. The base station may thus have to perform decoding on the received signal. If small data is indeed transmitted together with the control message, the base station will successfully decode the small data. On the other hand, if no small data is transmitted together with the control message, the base station will not successfully decode any data.

According to further variants of the data transmission procedure, which can be combined with other variants and implementations of the data transmission procedure, the base station, in response to the receiving the control message and small data, may decide to transmit a response message back to the UE. The base station may e.g. decide on the state the UE should be, e.g. stay in the inactive state, change to the connected or idle state. The decision by the base station may be based on e.g. one or more of the following: whether the base station can successfully retrieve UE's context, whether the transmitted small data is the end of a traffic burst (e.g., there is no more small-data transmission after this one), and the cause indicated in the control message. According to one example, the base station is able to determine that there is no more small data, based on whether there is a buffer status report after the small data. The buffer status report indicates that further small data is available for transmission, which could be one reason to transition the UE to the connected state.

As a result, the response message may include a corresponding UE-state indication for the UE. The UE receives this response message and follows the instruction therein to maintain or change into the indicated state.

According to a further variant that can be used in addition to the other variants, the response message from the base station to the UE can also schedule radio resources for the UE, which can be used by the UE to transmit further small data to the base station, in case the base station determined that the already transmitted small data is not the end of the traffic burst.

According to a further variant that can be used in addition to the other variants, the response message from the base station to the UE can also indicate a new cell-specific UE ID that is newly assigned by the base station to the UE. For instance, in scenarios where the new base station becomes the new anchor base station for the UE, the new anchor base station can assign a new cell-specific UE ID to the UE to be used by the UE while in the inactive state in the radio cell of the new anchor base station. The UE, when receiving the new cell-specific UE ID, can replace the old invalid cell-specific UE ID (assigned by the old base station) with the newly-assigned cell-specific UE ID, and use same in future communication with the new anchor base station.

A further variant that can be used in addition to the other variants, relates to how to react to a failure in the base station to properly identify a UE, based on the cell-specific UE ID received from the UE with the small data. In particular, it is exemplarily assumed that the UE stays in the same radio cell while in the inactive state, but that the base-station (gNB) after some time releases the cell-specific UE ID such that it is no longer reserved for and associated with the UE. Assuming that this release is invisible to the UE, the UE would select the cell-specific UE ID for use in the small data transmission because it correctly determines that it is still located in the same old radio cell. The base-station (gNB) however fails to properly identify the received cell-specific UE ID and thus fails to retrieve the relevant UE context for decoding the small data. In response, the base-station (gNB) may transmit a response message to the UE indicating this failure, in response to which the UE then may transmit back the non-cell-specific UE ID. On the basis of the non-cell-specific UE ID, the base station may now proceed to retrieve the UE context and decode the small data.

In a further exemplary variant thereof, the base station may newly assign a cell-specific UE ID to the UE, and inform the UE accordingly about this newly-assigned cell-specific UE ID for future communication.

In the variants and implementations of the data transmission procedure described so far, it was assumed that the UE has a data connection available while the UE is in the inactive state, which then can be used for the small-data transmission. This can be achieved in different ways.

Typically, when the UE is in the connected state, it will have several active data connections that are used to exchange data and possibly other non-suspended data connections that are currently not used but still available for immediate use if needed.

According to an additional optional implementation, when being in the inactive state, the UE does not suspend at least one of these data connections the UE had established when in the connected state. In other words, the UE maintains at least one data connection as non-suspended, and thus available for immediate use during the inactive state. The remaining data connections, which the UE had established in the connected state, can be suspended by the UE when being in in the inactive state. For instance, the UE may decide to not suspend one or more data connections associated with an application that is likely to cause a small-data transmission when in the inactive state. In another example, the UE may decide to not suspend the data connection that is being configured by base station as the default data connection fulfilling the minimal QoS requirement.

The base station will operate in a corresponding manner, by not suspending at least one of the data connections that were established with the UE, while the UE was in the connected state. The data connection maintained by the base station and the UE as non-suspended should be the same one, in order to facilitate the successful transmission and decoding of the small data transmitted using this common non-suspended data connection.

According to an additional optional implementation, when being in the inactive state, the UE does not suspend any of the data connections that the UE had established with base station, i.e. UE maintains all data connections as non-suspended. The base station will operate in a corresponding manner, by not suspending any of the data connection that it had already established with the UE, while the UE was in connected state. Correspondingly, when the UE needs to transmit small data while in the inactive state, the UE selects the data connection suitable for the small data, and uses this selected data connection to carry the data to the base station. The base station will thus be able to properly receive and decode the small data received via the data connection, selected by the UE.

According to an additional optional implementation, when being in the inactive state, the UE and base station both suspend all data connections of the connected state established between them. However, when being in the inactive state, one or more new data connections can be created between the UE and the base station, which are kept in a non-suspended state while the UE is in the inactive state. For instance, a new data connection can be created specific for small-data transmissions that may occur while the UE is in the inactive state, e.g. the corresponding parameters associated with the new data connection being tailored for a small-data transmission.

This new data connection can be also be implemented as a default inactive-state-specific data connection, available in UEs that are in the inactive state. For instance, the parameters and settings related to the default data connection are hardcoded in the UE as defined by a 3GPP technical standard. The default data connection can then be created by the UE and base station automatically using these parameters and setting when the UE is transitioned to the inactive state.

According to an additional optional implementation, the described different variants and implementations of the data transmission procedure (and combinations thereof) can be implemented in existing communication systems, such as the LTE, LTE-A, 5G NR communication systems. In the following, it is exemplary described how the improved data transmission procedure could be implemented in communication systems according to the 5G NR standards.

According to the above-described data transmission procedure, the UE is transmitting the small data as well as the control message, including the previously determined UE ID, to the radio base station. In one exemplary variant of the data transmission procedure, which can be combined with the other variants, the small data and control message are transmitted as part of a random access procedure. As presented in previous parts of the description, to which reference is made herewith, 3GPP 5G NR provides a 2-step RACH procedure and a 4-step RACH procedure. For instance, when performing a 2-step RACH procedure, the small data and control message can be transmitted as part of the first message (msgA) of the 2-step RACH procedure. The remaining 2-step RACH procedure as currently defined in 3GPP (reference is made to the corresponding part of the description above), can be adopted for the data transmission procedure, for instance including the transmission of MSGB by the base station and corresponding reception in the UE.

On the other hand, when performing a 4-step RACH procedure, the small data and control message can be transmitted as part of the third message (msg3) of the 4-step RACH procedure. The remaining 4-step RACH procedure as currently defined in 3GPP can be adopted for the data transmission procedure. For instance, this includes the previous transmission of a preamble as the first step, then in the second step the reception of the RAR including a grant of limited radio resources for the transmission of msg3 in the third step, and in the last fourth step the potential contention resolution. The radio resources scheduled by the radio base station in the RAR are used by the UE to transmit both the small data and control message as the msg3. For instance, a typical grant size is 72 bits, which is used to carry both the control message and the small data. Accordingly, the bigger the control message, the less use data can be transmitted in the remaining msg3. Thus, it is important that the control message and specifically the carried UE ID is as small as possible to facilitate carrying more data in the remaining part of msg3 (for instance in the same transport block the UE builds using the granted radio resources; different data/signaling radio bearer being multiplexed together in the same transport block in the MAC layer.

In the RACH procedure of the prior art, the base-station (gNB) only expects msg3 of the 4-step RACH procedure and msgA of the 2-step RACH procedure to include the RRC message, such as an RRCResumeRequest message. Thus, the base-station (gNB) would not expect any small data to be transmitted with msg3, respectively msgA. On the other hand, the gNB according to the improved data transmission procedure should be prepared for both cases, namely the case that msg3/msgA only carries the control message and the case that the msg3/msgA carries the control message as well as small data.

As described above for the data transmission procedure, a non-cell-specific UE ID or a cell-specific UE ID are transmitted in a control message together with the small data. In the following, numerous different possible UE IDs will be presented that can be respectively used as the non-cell-specific UE ID and cell-specific UE ID.

In 5G NR there is the I-RNTI and the short I-RNTI (see TS 38.331 v15.8.0 section 6.3.2), each of which could be used as the non-cell-specific UE ID. The I-RNTI has 40 bits, and is composed differently, depending on the I-RNTI reference profile. On the other hand, the short I-RNTI has less bits than the full I-RNTI, in particular 24 bits.

The following table shows the three different profiles for the full I-RNTI, which are described in 3GPP TS 38.300 v16.0.0 annex C).

| | | NG-RAN node | | | |
|---|---|---|---|---|---|
| | | address index | RAT- | PLMN- | |
| Profile | UE specific | (e.g., gNB | specific | specific | |
| ID | reference | ID, eNB ID) | information | information | Comment |
| 1 | 20 bits | 20 bits | N/A | N/A | NG-RAN node |
| | (~1 million | (~1 million | | | address index |
| | values) | values) | | | may be very |
| | | | | | well |
| | | | | | represented by |
| | | | | | the LSBs of the |
| | | | | | gNB ID. |
| | | | | | This profile may |
| | | | | | be applicable |
| | | | | | for any NG-RAN |
| | | | | | RAT. |
| 2 | 20 bits | 16 bits | N/A | 4 bits (Max | Max number of |
| | (~1 million | (65.000 | | 16 PLMNs) | PLMN IDs |
| | values) | nodes) | | | broadcast in NR |
| | | | | | is 12. |
| | | | | | This profile may |
| | | | | | be applicable |
| | | | | | for any NG-RAN |
| | | | | | RAT. |
| 3 | 24 bits | 16 bits | N/A | N/A | Reduced node |
| | (16 million | (65.000 | | | address to |
| | values) | nodes) | | | maximize |
| | | | | | addressable UE |
| | | | | | contexts. |
| | | | | | This profile may |
| | | | | | be applicable |
| | | | | | for any NG-RAN |
| | | | | | RAT. |

As apparent, the I-RNTI comprises different parts, a UE-specific reference (ID) and a NG-RAN node address (such as the base-station (gNB) ID) as well as PLMN specific information for profile 2. The size of the full I-RNTI is quite large, thus taking much space of the msg3 (e.g. 72 bits available in total) grant or of the msgA PUSCH part (e.g. 200 bits available in total). As a result, less small data can be transmitted, making the small-data transmission less efficient. However, the full I-RNTI can uniquely identify a UE within e.g. the PLMN.

On the other hand, the short I-RNTI (can also be called Truncated I-RNTI) has only 24 bits, e.g. taking the 12 LBS from the UE-specific reference and the 12 LSB bits from the base-station (gNB) ID. Correspondingly, the size of the short I-RNTI is significantly less than the size of the full I-RNTI, allowing more small data to be transmitted in the msg3 or msgA. However, UE ID collisions are more likely to occur, in specific deployment scenarios (such as when there are thousands of base-station (gNBs) within a PLMN and/or when there are thousands of inactive UEs camping on one base-station (gNB).

In current 5G NR systems, the UE is configured by the base-station (gNB) to use either the full or short I-RNTI (e.g. as part of SIB1). Thus, exemplary, the UE, when performing the improved data transmission procedure and deciding to use the non-cell-specific UE ID for the small-data transmission, uses the full or short I-RNTI in line with the indication from the base-station (gNB).

With respect to the cell-specific UE ID, there are several possibilities, such as using the UE-specific part of I-RNTI, the C-RNTI or a small-data-specific UE ID, as will be explained in the following. As discussed above, the cell-specific UE ID is used by the UE for the small-data transmission when staying in the same radio cell in which the cell-specific UE ID is valid. Put differently, the cell-specific UE ID, if possible, should not be used when the UE is in a new radio cell.

According to an additional optional implementation, the UE-specific part of the I-RNTI (see above table), which is 20 bits long, can be used as the cell-specific UE ID in the data transmission procedure. Correspondingly, the cell-specific UE ID is smaller than both options of the non-cell-specific UE ID. However, which bits of the full I-RNTI identify the UE (and which bits identify the base-station (gNB)) may be invisible to legacy UEs (according to Release 15 or 16). According to one exemplary implementation in said respect, the base-station (gNB) can additionally indicate to the UE from which bit to which bit inside the full I-RNTI identifies the UE.

According to a further second exemplary variant, the C-RNTI, which is 16 bits long, can be used as the cell-specific UE ID. The C-RNTI is even shorter than the above-discussed UE-specific part of the I-RNTI, and thus allows further improving the small-data transmission. In the current 5G NR communication systems, the base-station (gNB) releases the C-RNTI of the UE at the time when the UE moves to the RRC_INACTIVE state. However, for the data transmission method, it would be necessary that the gNB keeps the C-RNTI even after the UE is transitioned to the RRCJNACTIVE, so as to allow the UE to use the C-RNTI as the cell-specific UE ID.

According to another third exemplary variant, a new UE ID for small-data transmission can be defined, which can be 16 bits or less. This allows to further reduce the number of bits spent for the UE ID in the small-data transmission, thus allowing more small data to be transmitted. However, defining and maintaining yet another UE ID requires more processing at the base-station (gNB) side. In particular, the base-station (gNB) can maintain another cell-specific UE ID pool (similar to the C-RNTI) just for facilitating small-data transmission when the UE is in the inactive state.

According to a variant of the data transmission procedure, already discussed above in connection with cell-specific UE IDs, a new UE-ID-validity timer can be used to limit the time a cell-specific UE ID is reserved by the base-station (gNB) before releasing same to be available for re-assigning to another UE. This UE-ID-validity timer can be used e.g. in connection with the above-discussed C-RNTI and small-data-specific UE ID (second and third variants), such that it is possible to control when to release the C-RNTI (or small-data-specific UE ID) and avoid running out of C-RNTIs (or small-data-specific UE IDs). Considering that the UE-specific part of the I-RNTI (first variant) will not be reassigned, it is possible but not necessary to operate a UE-ID-validity timer when the UE-specific part of the I-RNTI is used as the cell-specific UE ID.

As described above for the data transmission procedure, a control message is transmitted by the UE to the base station, including the selected UE ID. There are several different possibilities on how the control message can be implemented in a 5G NR communication system. In some exemplary implementations, one or more of the following variants of the control message for paging can be implemented at the same time, and the UE then decides on which particular control message is used as the control message for the data transmission procedure.

Reception of the Paging message by the UE can be indicated by including the explanation of one short DL data or multi short DL data.

The small Data indication or one-shot downlink (DL) data would be 1-bit long. For example, when the new small Data indication or one-shot downlink (DL) data indicates true, the base-station (gNB) expects that small data (user data) is appended. The base-station (gNB) thus knows exactly when small data is transmitted and decoding of the small data or one shot downlink (DL) data is facilitated.

According to a variation of the RRC control message, an RRCResumeRequest and the PagingUE-Identity message as currently defined in 5G NR can be reused. without any further adaptation. The base-station (gNB), when receiving the the request thus does not know whether small data is also transmitted or not. Therefore, the gNB must be prepared for both cases, the first case being that no small data is transmitted together with the RRCResumeRequest, and the second case being that small data is transmitted together with the RRCResumeRequest. For instance, the base-station (gNB) will try to successfully decode any bits that are transmitted together with the RRCResumeRequest as to whether they constitute the transmission of small data or only spare bits.

According to an additional optional implementation, a RRC message is defined for the purpose of a small data transmission while in the UE inactive state. Since this RRC message will be used by the UE for the small-data transmission, the base-station (gNB) expects that there is further user data (the small data) appended after this new RRC message.

In the example of the PagingUE-Identity message, the UE-Identity information element (IE) uses the CHOICE structure so as to allow the UE to choose among different UE ID formats. In order to avoid repetition, reference is made to the above discussion on the different 5G NR compliant implementations of the non-cell-specific UE and the cell-specific UE ID, such as the full I-RNTI (in above message ‘I-RNTI-Value”), the short I-RNTI (in above message “short I-RNTI-Value”), and the U E-specific-part of I-RNTI (in above message “UE-I-RNTI-Value”). In the above example, the UE would select either the full or short I-RNTI as the non-cell-specific UE ID, and would have only one option for the cell-specific UE ID, particularly the U E-specific part of the I-RNTI.

In the above solutions, the control message was a message of the RRC protocol. Other variants of the data transmission procedure use a message of the MAC protocol as the control message. It should be noted that MAC Control Elements are typically not integrity protected and thus less secure that RRC messages. Nevertheless, MAC messages can be smaller in size, which leads to less control overhead such that more small-data can be transmitted instead.

One possible implementation of the MAC control message is based on a new Medium Access Control Control Element (MAC CE) format to carry one of the possible UE IDs mentioned above. A new LCID (Logical Channel ID) value is reserved for the new Medium Access Control Control Element (MAC CE) so as to be indicated in the Medium Access Control (MAC) subheader.

In case the C-RNTI is used as the cell-specific UE ID, the already existing C-RNTI Medium Access Control Control Element (MAC CE) can be reused (see TS 38.321 v15.8.0 section 6.1.3.2). However, by reusing this existing C-RNTI Medium Access Control Control Element (MAC CE), no additional small-data indication or cause can be transmitted to the base-station (gNB). The base-station (gNB) thus needs to be prepared to decode small data after receiving a C-RNTI Medium Access Control Control Element (MAC CE). However, the base-station (gNB) may implicitly understand that the UE is transmitting small data when receiving such a C-RNTI Medium Access Control Control Element (MAC CE) as part of the RACH procedure (which normally would include an RRC message).

According to further variants, the base-station (gNB) may decide which UE state is the most appropriate for the UE and then transmit a corresponding RRC-UE-state indication back to the UE as part of a response message (see UE-state indication variant discussed above). According to one exemplary implementation, the decision of the base-station (gNB) can be based on one or more of the following: the resume cause indicated in the RRCResumeRequest, whether user data is appended after the RRCResumeRequest, whether the appended user data is the end of the traffic.

The response message can be either a new message defined for said purpose and being able to carry the corresponding RRC-UE-state indication.

In other solutions, an already existing RRC message can be reused. For instance, when using the RRCResumeRequest message as the control message, the base-station (gNB) may respond using the RRCResume message, e.g. as part of the RACH procedure. The RRCResume message would indicate the RRC UE state in which the UE should be. The currently-defined RRCResume message of 5G NR in TS 38.331 v15.8.0 section 6.2.2 can be extended.

In a different scenario, the (presumably-new) base-station (gNB) is indeed the anchor base-station (gNB) for the UE, e.g. when the UE is located in a new radio cell which however belongs to the same base-station (gNB) as the previous radio cell. Also in such a case, the UE will transmit the control message with the non-cell-specific UE ID, such as the full I-RNTI, although it may have used the cell-specific UE ID instead. In response to the control message, the base-station (gNB) may respond by sending the cell-specific UE ID to the UE, thereby indicating that the base-station (gNB) is also the anchor base-station (gNB) for the UE for the new radio cell. Correspondingly, the UE thereby is made aware that the new radio cell belongs to the same base-station (gNB) as before, and in future communication (such as a new small-data transmission), the UE can use the short cell-specific UE ID.

In the above described variants and implementations of the data transmission procedure, the UE, when determining which UE ID to use for the small-data transmission, determines whether, after having transitioned to the inactive state, it has moved to a new radio cell or not. In exemplary variants of the improved data transmission method, the determination of the radio cell in which the UE is currently located can be performed as follows. Radio base stations may broadcast signals (such as synchronization signals or system information) in their radio cells, these signals being such that they allow determining the ID of the radio base station (or radio cell). The UE, when in the inactive state, receives the signals and is able to determine the radio cell it is currently located in. For instance, in an exemplary 5G NR implementation primary and secondary synchronization signals (see SS/PBCH blocks; Synchronization Signal/Physical Broadcast Channel blocks) are transmitted by the base-station (gNB) and correspondingly decoded by the UE, which allows to identify the time slot and physical cell ID of the camped radio cell (see 3GPP TS 38.211v16.0.0 e.g. sections 7.4.2 and 7.4.3). In such 5G NR implementation, the UE identifies the radio cell based on the physical cell ID (PCI), but does not identify the based station (gNB). In deployments where one base-station (gNB) control several radio cells, the UE would not be able to know that the new radio cell (after the cell change while in inactive state) belongs to the same base-station (gNB) as the previous radio cell before the radio cell change (cell reselection). In the improved data transmission procedure, the UE would thus still use the non-cell-specific UE ID to be transmitted with the small data.

Numerous variants and implementations of the data transmission procedure have been described. Some of these have been described separately from one another in order to be facilitate the understanding and benefits of the respective variant or implementation. However, it is equally possible to combine two or more of the variants and implementations of the data transmission procedure together to form new variants and implementations of the data transmission procedure. Without being exhaustive, and to just mention a few: small-data-indication variants, UE-ID-validity-timer variants, UE-state-indication variants, fallback-RAR variants, different variants of control messages, different variants of cell-specific UE IDs and non-cell-specific UE IDs, different variants of data connections by the UE.

### Further Aspects

According to a first aspect a method of wireless communication is provided. Comprising the following steps: receiving downlink control information (DCI) comprising by a user equipment (UE) in an inactive state (RRC_INACTIVE),
a cyclic redundancy check (CRC) scrambled by a radio network with at least one base-station (gNB) with identifier (C-RNTI) that is specific to a group of UEs,
the group of UEs including the UE, and a resource assignment for a data transmission from at least a base-station (gNB) to the user equipment (UE); and
receiving, by the user equipment (UE) in the inactive state (RRC_INACTIVE), the data transmission on a physical shared channel, wherein the user equipment (UE) receives more than one random-access channel (RACH) resource configuration.

According to a second aspect provided in addition to the first aspect, whereby the user equipment (UE) receives indication of priority of downlink (DL) data in the paging message.

According to a third aspect provided in addition to the first or second aspect, whereby user equipment (UE) receives indication of group ID in the paging message.

According to a fourth aspect provided in addition to one of the first or second aspects, whereby user equipment (UE) receives mapping between priority and group ID and random-access channel (RACH) resources configuration.

In an alternative implementation to the above MAC control message, the control message is of the Radio Resource Control, RRC, protocol, specifically one of the following:
an RRC Resume Request message, including a cause for transmitting the RRC Resume Request message, wherein the cause indicates a small data transmission as the cause for transmitting the RRC Resume Request message,
an RRC Resume Request message, including a cause for transmitting the RRC Resume Request message and including a small data indication,
an RRC Resume Request message, without including a small data indication and without indicating a small data transmission as the cause for transmitting the RRC Resume Request message,
a small-data-specific RRC message.

According to a fifth aspect provided in addition to one of the first to fourth aspects, whereby user equipment (UE) whereby mapping in the system information or dedicated RRC message.

According to a sixth aspect, provided in addition to one of the first to fifth aspects, whereby user equipment (UE) selects random-access channel (RACH) resources corresponding to the priority and/or group ID indicated in the paging message.

According to a seventh aspect, provided in addition to one of the first to sixth aspects, whereby base-station (gNB) configures more than one random-access channel (RACH) resources per Synchronization Signal Block (SSB).

In an optional implementation, the response message further indicates uplink radio resources to be used for transmitting data. The transmitter transmits further small data to the radio based station using the indicated uplink radio resources.

In a further optional implementation, the response message further indicates a new cell-specific UE ID, different from the already assigned cell-specific UE ID. The processor uses in future communication the newly-assigned cell-specific UE ID instead of the previously-assigned cell-specific UE ID.

According to a eighth aspect provided in addition to one of the first to seventh aspects, whereby base-station (gNB) configures a mapping of the random-access channel (RACH) resources based at least one option.

In an optional implementation, the receiver receives a new cell-specific UE ID from the radio base station, and the processor replaces the previous cell-specific UE ID with the newly-assigned cell-specific UE ID. According to an eighth aspect provided in addition to one of the first to seventh aspects, the processor, when being in the inactive state, does not suspend at least one data connection the UE had maintained in the connected state. In an optional implementation, the non-suspended at least one data connection is specific to the transmission of small data.

Alternatively, the processor, when transitioning to the inactive state, does not suspend any of the data connections the UE had maintained in the connected state.

Alternatively, the processor, when transitioning to the inactive state, suspends all data connections the UE had maintained in the connected state and creates a new data connection specific to the transmission of small data.

According to a ninth aspect, a method is provided in addition to one of the first to eighth, whereby the option is a selection of priorities P1, P2 and P3 and priority P1 is linked to random-access channel (RACH) resources 1, priority P2 is linked to random-access channel (RACH) resources 2, priority P3 is linked to random-access channel (RACH) resources 3.

According to a tenth aspect, a method is provided in addition to one of the first to nineth aspects, the option is a selection of group ID1, group ID2 and group ID3 and group ID1 is linked to random-access channel (RACH) resources 1, group ID2 is linked to random-access channel (RACH) resources 2, group ID3 is linked to random-access channel (RACH) resources 3.

According to an eleventh aspect, the mapping is done through system Information or dedicated RRC message.

According to a twelfth aspect, a method is provided in addition to one of the first to eleventh aspects, base-station (gNB) indicates priorities P1, P2, P3 and/or group ID1, group ID1, group ID2, group ID3 in the paging message and user equipment (UE) selects random-access channel (RACH) resources.

According to a thirteenth aspect, a method is provided in addition to one of the first to twelfth aspects, base-station (gNB) change number of random-access channel (RACH) resources based on the overall load situation.

According to a fourteenth aspect the user equipment (UE) for wireless communication is provided, comprising: a memory; and one or more processors coupled to the memory, the memory and the one or more processors configured to: receive, from a base-station (gNB), a paging communication while the user equipment (UE) is in an inactive mode or an idle mode (RRC_IDLE); transmit, to the base-station (gNB) and based at least in part on receiving the paging communication, a first communication as part of a random access channel (RACH) procedure; and receive, from base-station (gNB) and based at least in part on transmitting the first communication, a second communication that includes: mobile-terminated downlink data, an indication of an uplink resource, and a radio resource control (RRC) release message that causes the user equipment (UE) to remain in the inactive mode or the idle mode while receiving the mobile-terminated downlink data; and transmit, to a base-station (gNB) and while in the inactive mode or the idle mode, mobile-originated uplink data using the uplink resource, wherein the memory stores computer program instructions which, when executed by the microprocessor, configure the user equipment (UE) to implement the method of one or more of the first through thirteenth aspects.

According to a fifteenth aspect a base-station (gNB) for wireless communication is provided, comprising: a memory; and one or more processors coupled to the memory, the memory and the one or more processors configured to: transmit, to a user equipment (UE), a paging communication while the user equipment (UE) is in an inactive mode (RRC_INACTIVE) or an idle mode (RRC_IDLE); receive, from the user equipment (UE) and based at least in part on transmitting the paging communication, a first communication as part of a random access channel (RACH) procedure; and transmit, to the user equipment (UE) and based at least in part on transmitting the first communication, a second communication that includes: mobile-terminated downlink data, an uplink (UL) resource that the user equipment (UE) is to use to transmit mobile-originated uplink data while in the inactive mode or the idle mode, and a radio resource control (RRC) release message that causes the user equipment (UE) receive the mobile-terminated downlink (DL) data while in the inactive mode (RRC_INACTIVE) or the idle mode (RRC_IDLE); and receive, from the user equipment (UE) and in the uplink (UL) resource, mobile-originated uplink data, the user equipment (UE) is to transmit the mobile-originated uplink data while in the inactive mode or the idle mode, wherein the memory stores computer program instructions which, when executed by the microprocessor, configure the user equipment (UE) via the base-station (gNB) to implement the method of one or more of the first through thirteenth aspects.

According to a sixteenth aspect a non-transitory computer-readable medium storing one or more instructions for wireless communication is provided, the one or more instructions comprising: one or more instructions that, when executed by one or more processors of a user equipment (UE), cause the one or more processors to: receive, from base-station (gNB), a paging communication while the user equipment (UE) is in inactive mode (RRC_INACTIVE) or the idle mode (RRC_IDLE);
transmit, to the base-station (gNB) and based at least in part on receiving the paging communication, a first communication as part of a random access channel (RACH) procedure; and receive, from the base-station (gNB) and based at least in part on transmitting the first communication, a second communication that includes:
mobile-terminated downlink data, an indication of an uplink resource, and a radio resource control (RRC) release message that causes the user equipment (UE) to remain in the in inactive mode (RRC_INACTIVE) or the idle mode (RRC_IDLE), while receiving the mobile-terminated downlink data; and transmit, to the base-station (gNB) and while in inactive mode (RRC_INACTIVE) or the idle mode (RRC_IDLE), mobile-originated uplink data (UL) using the uplink resource, wherein the non-transitory computer-readable medium stores computer program instructions which, when executed by the microprocessor, configure the user equipment (UE) to implement the method of one or more of the first through thirteenth aspects.

According to a seventeenth aspect a non-transitory computer-readable medium storing one or more instructions for wireless communication is provided, the one or more instructions comprising: one or more instructions that, when executed by one or more processors of a base-station (gNB), cause the one or more processors to: transmit, to a user equipment (UE), a paging communication while the user equipment (UE) is in inactive mode (RRC_INACTIVE) or the idle mode (RRC_IDLE); receive, from the user equipment (UE) and based at least in part on transmitting the paging communication, a first communication as part of a random access channel (RACH) procedure; and transmit, to the user equipment (UE) and based at least in part on transmitting the first communication, a second communication that includes:
mobile-terminated downlink data, an uplink (UP) resource that the user equipment (UE) is to use to transmit mobile-originated uplink (UP) data while in inactive mode (RRC_INACTIVE) or the idle mode (RRC_IDLE), and
a radio resource control (RRC) release message that causes the user equipment (UE) receive the mobile-terminated downlink (DL) data while in inactive mode (RRC_INACTIVE) or the idle mode (RRC_IDLE), and
receive, from the user equipment (UE) and in the uplink (UL) resource, mobile-originated uplink data, the user equipment (UE) is to transmit the mobile-originated uplink (UL) data while in inactive mode (RRC_INACTIVE) or the idle mode (RRC_IDLE),
wherein the non-transitory computer-readable medium stores computer program instructions which, when executed by the microprocessor, configure the user equipment (UE) to implement the method of one or more of the first through thirteenth aspects.

According to a further beneficial aspect, provided in addition to all the other aspects, the UE is in a connected state having at least one data connection already established between the UE and the radio base station. The processor determines to transition the UE into an inactive state. A transmitter instructs the UE to transition into the inactive state. The processor determines to not suspend the at least one data connection already established between the UE and the radio base station in the connected state. The one data connection used for the small data transmission is one of the non-suspended at least one data connection.

In an optional implementation, the non-suspended at least one data connection is specific to the transmission of small data.

According to a further aspect, provided in addition to all the other aspects, the UE context is either stored locally within the radio base station, or retrieved from another radio base station.

Alternatively, the processor, when being in the UE to the inactive state, does not suspend all data connections already established between the UE and the radio base station in the connected state. The one data connection used for the small data transmission is one of the non-suspended data connections.

Alternatively, the processor, when transitioning the UE to the inactive state, suspends all data connection already established between the UE and the radio base station in the connected state, and establishes the one data connection with the UE, optionally wherein the newly established one data connection is specific to the transmission of small data.

According to a further aspect, provided in addition to all the other aspects, the processor determines that the UE, after having transitioned to the inactive state, has moved to the radio base station from a different radio base station, based on the received UE identification, the UE identification being a non-cell-specific UE identification. The processor determines the different radio base station, based on the non-cell-specific UE identification. The radio base station comprises a transmitter, which transmits, to the different radio base station, a request for a context of the UE. The receiver receives, from the different radio base station, a response including the context of the UE. The processor decodes the received small data using the received context of the UE.

According to a further aspect, provided in addition to all the other aspects, the cell-specific UE identification is assigned by the radio base station to the UE. The processor operates a UE-I D-validity timer for the cell-specific UE identification. The processor starts the UE-ID-validity timer, when the UE transitions from a connected state to the inactive state. The processor, when determining that the UE-I D-validity timer has expired for the cell-specific UE identification, considers the value of the cell-specific UE identification to no longer be associated with the UE but to be available for association with another UE. According to a fifteenth aspect, provided in addition to one of the tenth to fourteenth aspects, the transmitter transmits a response message to the UE in response to the received control message. The response message includes an indication instructing the UE to stay in the inactive state or to transition to one of a connected state or an idle state.

### Hardware and Software Implementation of the Present Disclosure

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an 1C (integrated circuit), a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT).

The communication may include exchanging data through, for example, a cellular system, a wireless LAN system, a satellite system, etc., and various combinations thereof.

The communication apparatus may comprise a device such as a controller or a sensor, which is coupled to a communication device performing a function of communication described in the present disclosure. For example, the communication apparatus may comprise a controller or a sensor that generates control signals or data signals, which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Further, the various embodiments may also be implemented by means of software modules, which are executed by a processor or directly in hardware. Also a combination of software modules and a hardware implementation may be possible. The software modules may be stored on any kind of computer readable storage media, for example RAM, EPROM, EEPROM, flash memory, registers, hard disks, CD-ROM, DVD, etc. It should be further noted that the individual features of the different embodiments may individually or in arbitrary combination be subject matter to another embodiment.

It would be appreciated by a person skilled in the art that numerous variations and/or modifications may be made to the present disclosure as shown in the specific embodiments. The present embodiments are, therefore, to be considered in all respects to be illustrative and not restrictive.

1. A method of wireless communication comprising the following steps:
receiving downlink control information by a user equipment in an inactive state, wherein the downlink control information comprises a cyclic redundancy check scrambled by a radio network with at least one base-station and a paging-Radio Network Temporary Identifier;
monitoring a paging message with the user equipment in inactive state;
using the paging-Radio Network Temporary Identifier to decode reception of paging message; and
receiving with the user equipment more than one random-access channel resource configuration.

2. The method according to claim 1, further comprising receiving indication of priority of downlink data in the paging message with the user equipment.

3. The method according to claim 2, further comprising receiving indication of a group ID in the paging message with user equipment.

4. The method according to claim 3, further comprising receiving mapping between priority and the group ID and random-access channel resources configuration with the user equipment.

5. The method according to claim 4, further comprising mapping in the system information or dedicated RRC message with the user equipment.

6. The method according to the claim 4, further comprising selecting random-access channel resources corresponding to at least one of the priority and group ID indicated in the paging message with the user equipment.

7. The method according to the claim 1, further comprising configuring more than one random-access channel resources per Synchronization Signal Block with the base-station.

8. The method according to the claim 7, further comprising configuring configures a mapping of the random-access channel resources based on at least one option with the base-station.

9. The method according to the claim 8, wherein the option is a selection of priorities P1, P2 and P3 and
priority P1 is linked to random-access channel resources 1,
priority P2 is linked to random-access channel resources 2, and
priority P3 is linked to random-access channel resources 3.

10. The method according to the claim 8, wherein the option is a selection of group ID1, group ID2 and group ID3 and
group ID1 is linked to random-access channel resources 1,
group ID2 is linked to random-access channel resources 2, and
group ID3 is linked to random-access channel resources 3.

11. The method according to the claim 8, wherein the mapping is done through system Information or dedicated RRC message.

12. The method according to the claim 8, further comprising indicating with the base-station priorities P1, P2, P3 and/or group ID1, group ID1, group ID2, group ID3 in the paging message and selecting with the user equipment the random-access channel resources.

13. The method according to the claim 8, further comprising changing with the base-station change the number of random-access channel resources based on the overall load situation.

14. A user equipment for wireless communication, comprising:
a memory; and one or more processors coupled to the memory, the memory and the one or more processors configured to:
receive, from a base-station, a paging communication while the user equipment is in an inactive mode or an idle mode;
transmit, to the base-station and based at least in part on receiving the paging communication, a first communication as part of a random access channel procedure; and
receive, from base-station and based at least in part on transmitting the first communication, a second communication that includes:
mobile-terminated downlink data, an indication of an uplink resource, and a radio resource control release message that causes the user equipment to remain in the inactive mode or the idle mode; while receiving the mobile-terminated downlink data; and transmit to a base-station while in the inactive mode or the idle mode, mobile-originated uplink data using the up link resource,
wherein the memory stores computer program instructions which, when executed by the microprocessor, configure the user equipment to:
receive downlink data;
monitor the paging message;
use a paging-Radio Network Temporary Identifier from the downlink data to decode the paging message; and
receive more than one random-access channel resource configuration in the downlink data.

15. A base-station for wireless communication, comprising:
a memory; and one or more processors coupled to the memory, the memory and the one or more processors configured to:
transmit, to a user equipment, a paging communication while the user equipment is in an inactive mode or an idle mode;
receive, from the user equipment and based at least in part on transmitting the paging communication, a first communication as part of a random access channel procedure; and transmit to the user equipment and based at least in part on transmitting the first communication, a second communication that includes: mobile-terminated downlink data, an uplink resource that the user equipment is to use to transmit mobile-originated uplink data while in the inactive mode or the idle mode, and a radio resource control release message that causes the user equipment receive the mobile-terminated downlink (DL) data while in the inactive mode or the idle mode; and receive, from the user equipment and in the uplink resource, mobile-originated up link data, the user equipment is to transmit the mobile-originated uplink data while in the inactive mode or the idle mode,
wherein the memory stores computer program instructions which, when executed by the microprocessor, configure the user equipment via the base-station to implement
receiving the downlink data;
monitoring the paging message;
using the paging-Radio Network Temporary Identifier to decode reception of the paging message; and
receiving more than one random-access channel resource configuration in the downlink data.

16. A non-transitory computer-readable medium storing one or more instructions for wireless communication, the one or more instructions comprising:
one or more instructions that, when executed by one or more processors of a user equipment, cause the one or more processors to:
receive, from base-station, a paging communication while the user equipment is in inactive mode or the idle mode;
transmit, to the base-station and based at least in part on receiving the paging communication, a first communication as part of a random access channel procedure; and receive, from the base-station (gNB) and based at least in part on transmitting the first communication, a second communication that includes:
mobile-terminated downlink data, an indication of an uplink resource, and a radio resource control release message that causes the user equipment to remain in the in inactive mode or the idle mode, while receiving the mobile-terminated downlink data; and transmit, to the base-station and while in inactive mode or the idle mode, mobile-originated uplink data using the uplink resource,
wherein the non-transitory computer-readable medium stores computer program instructions which, when executed by the microprocessor, configure the user equipment to implement the method of
receiving the downlink data;
monitoring the paging message;
using the paging-Radio Network Temporary Identifier to decode reception of the paging message; and
receiving more than one random-access channel resource configuration in the downlink data.

17. A non-transitory computer-read able medium storing one or more instructions for wireless communication, the one or more instructions comprising:
one or more instructions that, when executed by one or more processors of a base-station, cause the one or more processors to:
Transmit, to a user equipment, a paging communication while the user equipment is in inactive mode or the idle mode;
receive, from the user equipment and based at least in part on transmitting the paging communication, a first communication as part of a random access channel procedure; and transmit, to the user equipment and based at least in part on transmitting the first communication, a second communication that includes: mobile-terminated downlink data, an uplink-(UP) resource that the user equipment is to use to transmit mobile-originated uplink data while in inactive mode or the idle mode, and a radio resource control release message that causes the user equipment receive the mobile-terminated downlink (DL) data while in inactive mode (RRC_INACTIVE) or the idle mode (RRC_IDLE), and
receive, from the user equipment and in the uplink resource, mobile-originated uplink data, the user equipment is to transmit the mobile-originated uplink (UL) data while in inactive mode or the idle mode,
wherein the non-transitory computer-readable medium stores computer program instructions which, when executed by the microprocessor, configure the user equipment to implement the method of
receiving the downlink data;
monitoring the paging message;
using the paging-Radio Network Temporary Identifier to decode reception of the paging message; and
receiving more than one random-access channel resource configuration in the downlink data.
